(19) United States
(12) Patent Application Publication
(10) Pub. No.: US 2025/0160376 A1
(43) Pub. Date: May 22, 2025

(54) Expanded Snack Food Product and Manufacture Thereof

(71) Applicant: Frito-Lay Trading Company GmbH, Berne (CH)

(72) Inventors: Debora Saibene, London (GB); Felicity Vincent, London (GB); Rebecca Baker, London (GB); Kirsty More, London (GB); Philip Cross, London (GB); Francesca Brannam, London (GB)

(21) Appl. No.: 18/839,627

(22) PCT Filed: Feb. 28, 2023
(86) PCT No.: PCT/IB2023/051866

§ 371 Date: Aug. 19, 2024

(30) Foreign Application Priority Data
Feb. 28, 2022 (GB) 2202757.7

(51) Int. Cl. A23L 19/00; A23L 29/10; A23L 29/212; A23P 30/10; A23P 30/38

(52) U.S. Cl. CPC A23L 19/09; A23L 29/10; A23L 29/212; A23P 30/10; A23P 30/38

(57) ABSTRACT

An expanded snack food product comprising a rigid matrix defining a cellular structure, and a batter for making an expanded snack food product comprising a substrate, an emulsifier and starch. A method of manufacture and a kit is also disclosed.

### FIELD OF THE INVENTION

The present invention relates to an expanded snack food and a method of manufacturing such expanded snack foods. In particular, the present invention relates to an edible substrate which is mixed with starch and an emulsifier to form a batter which is then dehydrated using microwaves to produce a non-fried, non-extruded expanded snack food product. The substrate may comprise minimally processed fruit, vegetables, nuts, seeds fungus and/or pulses which are mixed with the starch and emulsifier to form a batter, which is then dehydrated using a microwave to produce an non-fried, non-extruded expanded snack food product.

### BACKGROUND

Snack food products desirably have an attractive appearance and provide a pleasant mouthfeel, including a crunchy texture, which maybe achieved as a result of the expanded nature of the product. Such snacks are typically made from cereal and/or potato based doughs and their expanded nature is achieved as a result of extrusion followed by frying. Despite a desire for innovative snack food products, the use of alternative ingredients as the base or substrate for expanded snack food products is limited by factors such as moisture content: substrates which have a high moisture content hinder or makes economically unfeasible the forming and/or dehydration process. Examples of expanded snack food products include Cheetos® and Quavers® which are corn meal and potato based snacks respectively, created by extrusion followed by frying.

However, there is an increasing recognition of the need to consume healthy foods. In view of the calorie content of fried foods, snack food products which are produced without frying are desirable. Further to this, due to the rising consumer concern for health and well-being, snacks with a “clean label” are gaining popularity; i.e. snacks that comprise ingredients that are perceived by consumers as being natural, familiar, simple ingredients that are easy to recognize, understand and pronounce and are not artificial ingredients or synthetic chemicals; as well ingredients that are minimally processed. In addition, snack foods containing vegetables and/or fruit are gaining popularity for health and well-being reasons.

Traditional manufacturing processes present multiple challenges in forming and/or dehydrating fabricated snacks comprising vegetables and fruit. The use of fruit and vegetable in fabricated snack food manufacturing is often limited due to the inherent high moisture content of these ingredients which, as mentioned above, hinders or makes economically unfeasible the forming and/or dehydration process. This issue is often overcome using dehydrated materials (most commonly powders, followed by flakes) or by restricting the amount of fruit or vegetable to control the overall moisture of the mix. This latter approach does not allow for the manufacturing of snack foods with fruit or vegetables as the leading ingredients in the ingredient declaration.

As such, snacks comprising plant-based substrates are often manufactured from powders. For example, extruded then fried plant-based snack products typically contain 3-15% plant-based material which is derived from a plant-based powder. However, the dehydration of plant substrates typically results in loss of heat-labile nutrients, colour changes, altered reconstitution properties, reduced antioxidant activity and substandard sensory attributes. The use of plant-based powders to make snacks food products thus negatively impacts on the visual, nutritional and sensory properties of the snack, resulting in products with limited range of texture attributes (typically being fairly high density), faded flavours and dull colours.

Alternatively, fruit or vegetable based snacks may be manufactured by freeze-drying or otherwise dehydrating pieces of fruit or vegetable. This technique can help retain the flavour of the substrate, but the resultant product is not expanded in the way desired for a snack food.

Foam-mat drying (the whipping of a liquid or semi-liquid to a stable foam and subsequent dehydration by thermal means) can be used to create an aerated product, however such foams require the addition of foaming agents and foam stabilizers. For example, Ozcelik et al., (J. Food Eng. 2019. 240: 83-98) discloses creation of an expanded food product from a foam which comprises a highly whipped fruit with potato protease inhibitors as a foaming agent, and maltodextrin and pectin as foam stabilizers. The additional ingredients are essential for foam creation and stabilization, thereby allowing the expanded structure of the foam to be retained. If foam stability is unsatisfactory, collapse of the porous foam structure occurs resulting in a serious impairment of the drying process and a deteriorated product quality (Dachmann et al. Food & Bioprocess Tech (2018) 2253-2264).

A solution is therefore needed that allows simple (i.e. without the need for extrusion, whipping or foaming) production of a non-fried expanded snack food product. Such a solution could be applied so as to allow the use of high moisture substrates, such as plant substrates, to produce an expanded snack food product, preferably which contains few additional ingredients.

A microwave is a simple and rapid method of cooking food. A microwave is typically found in a home environment, so offers the opportunity for home preparation of snack products. Use of a microwave is economical, using up to 80% less energy than a conventional oven. It is known to use a microwave to rapidly create moist, puffed foods. For example, use of a microwave to create a puffed product from a dough comprising cereal flours was discussed in Pompe et al. (Food Process Eng. 2020, 43, e13429). EP0901754 concerns a kit for preparation of a cake in a microwave oven comprising instant cake mix to which edible oil, water and egg is added; and a mould.

However, the need remains for a non-fried, non-extruded expanded food snack food product which has a crunchy, non-cake-like texture, is capable of being simply manufactured and which can be used with high moisture food substrates.

The present disclosure aims to meet this need, and in one embodiments provides a non-fried, non-extruded expanded plant-based snack food product, and preferably a non-fried non-extruded expanded snack food product which comprises a high amount of plant-based content. The present disclosure also provides a method of manufacturing such snack food products, and a kit for preparing such snack food products.

### SUMMARY

Accordingly, in a first aspect, there is provided a non-fried, non-extruded, expanded snack food product comprising a plant-based substrate, emulsifier and starch, wherein the snack food product comprises an expanded rigid matrix comprising the plant-based substrate, and wherein the plant-based substrate comprises: (i) one or more fruits and/or vegetables; and (ii) no more than 20 wt % of the substrate in powdered or granulated form.

In some embodiments, the one or more fruits and/or vegetables are fresh fruits and/vegetables; or are fresh fruits and/or vegetables that have been frozen. In some embodiments, the plant-based substrate: (a) does not comprise more than 15 wt % wheat, maize, rice, barley, oats, millet, rye, sorghum, spelt, quinoa or buckwheat; (b) does not comprise more than 15 wt % potato; or (c) does not comprise a cereal crop.

In some embodiments, the snack food product comprises from about 15 wt % to about 70 wt % plant-based substrate based on the weight of the snack food product; optionally wherein the snack food product comprises from about 19 wt % to about 70 wt % plant-based substrate based on the weight of the snack food product.

In some embodiments, the matrix defines a cellular structure having a pore size distribution, wherein the pore size distribution: (a) has a number-average pore size Φ_{2D} within the range of from 300 to 1100 μm with a normalised standard deviation of from 0.8 to 1.8; (b) has a number-average pore size Φ_{3D} within the range of from 400 to 14000 μm, optionally wherein the pore size distribution has a number-average pore size Φ_{3D} within the range of from to 1150 and 1250 μm; and/or (c) has from 8×10² to 2×10⁴ pores per unit area Nᵥ, optionally wherein the pore size distribution has from about 8.5 to 9.9×10² pores per unit area Nᵥ and/or (d) wherein the cellular pores have a number-average anisotropy ratio Rₘₐₓ of from 1.4 to 2.2, optionally wherein the cellular pores have a number-average anisotropy ratio Rₘₐₓ of from 1.6-1.75; or 1.6 or 1.65.

In some embodiments, the moisture content of the snack food is from about 0.5 to about 5 wt %. In some embodiments, the starch is a pre-gelatinized starch.

In a second aspect, there is provided a batter for making a non-fried, non-extruded, expanded snack food product according to the first aspect wherein the batter comprises: (a) about 20% to about 95% plant based substrate; (b) about 0.3% to about 2.5% emulsifier; (c) about 8% to about 25% starch; (d) optionally, added water, wherein the batter has a moisture content of about 65 to about 85 wt % based on the weight of the batter.

In a third aspect there is provided a method for making a non-fried, non-extruded, expanded snack food product comprising: (i) providing a plant-based substrate comprising one or more fruits and/or vegetables; (ii) optionally processing the plant-based substrate to provide a rough puree; (iii) providing an emulsifier; (iv) providing a starch, optionally wherein the starch is a pregelatinized starch; (v) mixing the plant-based substrate, emulsifier and starch, optionally with added water, to form a batter having a moisture content of about 65 to about 85 wt % based on the weight of the batter; (vi) dispensing the batter into individual mould compartments; and (vii) dehydrating the batter using microwaves to produce a dehydrated product having a moisture content of around 2 to around 20 wt % based on the weight of the dehydrated product.

In some embodiments of the method, the plant-based substrate comprises no more than 20 wt % substrate in powdered or granulated form. In some embodiments of the method the one or more fruits and/or vegetables are fresh fruits and/vegetables, or are fresh fruits and/or vegetables that have been frozen. In some embodiments of the method the plant-based substrate: (i) does not comprise more than about 30 wt % cereal crop; (ii) does not comprise more than about 15 wt % wheat, maize, rice, barley, oats, millet, rye, sorghum, spelt, quinoa or buckwheat; and/or (iii) does not comprise more than about 15 wt % potato.

In some embodiments the method further comprises (viii) a finishing step to provide a finished product having a moisture content about 3-10 wt % based on the weight of the finished product, optionally wherein the finishing step comprises baking the product.

In a fourth aspect there is provided a snack food product obtained by a method according to the third aspect.

In a fifth aspect there is provided a kit for making a non-fried, non-extruded, expanded snack food product, wherein the kit comprises a batter according to the second aspect, optionally further comprising one or more individual mould compartments for use with the batter; or a quantity of emulsifier and starch sufficient to mix with a quantity of a plant-based substrate comprising one or more fruits and/or vegetables and, optionally, added water, to produce a batter having a moisture content of about 65 to about 85 wt % based on the weight of the batter; optionally further comprising one or more individual mould compartments for use with the batter. In some embodiments of the kit, no more than 20 wt % of the plant-based substrate is in powdered or granulated form.

### FIGURES

Embodiments of the present invention will now be described by way of example only, with reference to the accompanying drawings, in which:

FIG. 1 shows a flow chart illustrating a method of manufacturing a snack food product in accordance with a first embodiment;

FIG. 2 illustrates how a given cellular pore is measured to determine the cellular pore size dimension;

FIG. 3 shows how the anisotropy ratio Rᵢ is calculated from the maximum width value tₘₐₓ and a value tₚₑᵣₚ of the width that is perpendicular to the maximum width;

FIG. 4A shows an SEM of the cellular structure of two prototype products, (a) and (b), which comprise starch, an emulsifier and water; FIG. 4B shows a graph of cell size distribution (number and volume) of the cellular structures shown in FIG. 4A.

FIG. 5A shows a cross-section, taken by SEM, through a two Cheetos® ((a) and (b)); FIG. 5B shows a graph of cell size distribution (number and volume) of the cellular structures shown in FIG. 5A.

FIG. 6 show images of finished snack food products according an embodiment of the present disclosure made from vegetable purees consisting of (from left to right): beetroot, parsnip, green pea, sweet potato, mushroom and red pepper;

FIG. 7 shows images of finished snack food products made with varying amounts of starch: (from left to right): 5 wt %, 8 wt %, 12 wt % 15 wt %, 20 wt %, 25 wt % starch (for both FIGS. 7A and 7B)

FIG. 8 shows images of finished products made with native starch: maize starch (A); waxy maize starch (B); potato starch (C); in each case the inset image shows the transverse view of the product.

FIG. 9 shows images of finished products made without emulsifier (A); without salt (B); or with 5 wt % starch (C);

FIG. 10 shows images of finished products made with varying amounts of water added to the batter: 15 wt % (A); 30 wt % (B); 45 wt % (C); 60 wt % (D); and 75 wt % (E) added water;

FIG. 11 shows a cross-section, taken by scanning electron microscopy (SEM), through finished products made with: high starch (A); Dimodan® (B); lecithin (C); low starch (D).

FIG. 12A shows an SEM of the cellular structure of the matrix of product (C) in FIG. 11, with a corresponding mask for analysis; FIG. 12B shows a graph of cell size distribution (number and volume) of the cellular structure shown in FIG. 12A.

FIG. 13 shows an image of a ‘puffed’ snack food comprising a plant based substrate made according to currently available literature;

FIG. 14 shows images of finished snack food products according an embodiment of the present disclosure, made according to Example 9, with the following substrates: Apple puree (hemi-spherical and elongated mould compartments) (A); Doritos® hot salsa (B); Gazpacho soup (C); PepsiMax® (D) and Sweetcorn and Doritos® Salsa (E).

### DESCRIPTION

The present disclosure is based on the surprising finding by the inventors that a non-fried, non-extruded expanded product having a texture and mouthfeel similar to a traditional (extruded then fried) snack product could be produced by providing a mixture of starch, emulsifier and water, dispensing the mixture in a mould, and dehydrating the mixture with microwaves. A further surprising finding was that this technique could be applied to the creation of a desirable snack food product by the addition of a substrate which imparts a desirable property to the matrix, for example a desirable taste, colour and/or nutritional content. The inventors surprisingly found that this teaching could be applied to a very wide variety of substrates, including high or very high moisture content substrates.

In some embodiments the substrate is a plant-based substrate, thereby providing a snack food product which has a desirable ingredient list, texture, mouthfeel and taste.

Accordingly, the present disclosure concerns a non-fried, non-extruded expanded snack food product; and a method of making such products.

The methods of the present disclosure involve providing a batter which comprises a mix of a desirable substrate, such as a plant-based substrate, an emulsifier, a starch, and optionally added water. The batter is then dehydrated using microwaves before optionally finishing using a conventional dehydrating means such as an oven. The method does not involve extrusion, and the resultant snack food product is not an extruded product.

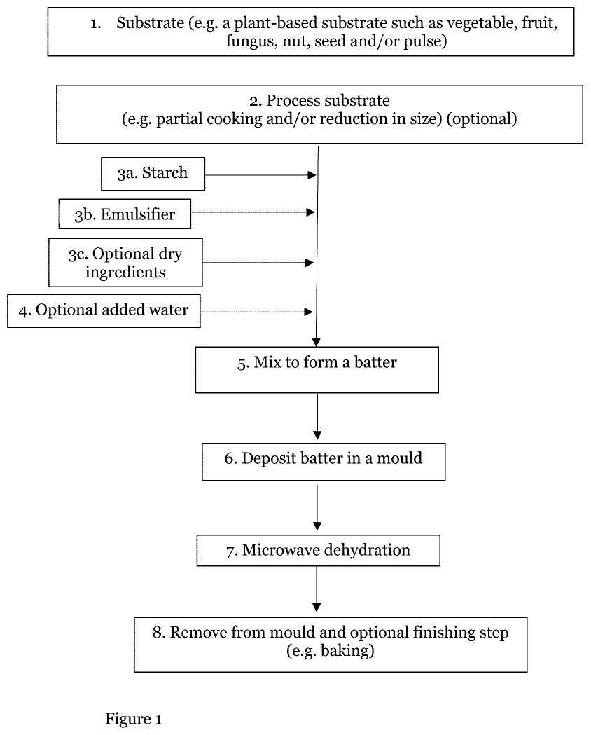

The flow chart in FIG. 1 illustrates one embodiment of a method of manufacturing a product according to the present disclosure.

### Substrate

Step 1 of the method concerns selection of a substrate.

The substrate may be any food or drink.

In some embodiments, the substrate is a soft drink, such as a cordial or a carbonated drink.

In some embodiments, the substrate is a dairy based substrate, such as a dairy product, a dairy based product, or a product derived from a diary product such as milk, flavoured milk, ice-cream, or yoghurt, or a combination thereof. In some embodiments, the substrate is ice-cream.

The term ‘ice cream’ encompasses a range of products, with the definition varying by region. For example, the US Food And Drug Administration definition specifies a frozen product and includes the requirement that the product contains not less than 10 percent milkfat; under UK Food labelling Regulations, products sold as ‘ice cream’ in the UK must include at least 5% fat and 2.5% milk protein. Any product described as ice cream may be used as a substrate in the present disclosure.

In some embodiments, the substrate is a dairy substitute, such as soy milk, oat milk or a nut milk.

In some embodiments, the substrate maybe dehydrated, such as a granular or powdered substrate. In some such embodiments, the substrate may be a base for a product, such as custard powder, cake mix, bread mix, pancake mix or muffin mix.

In some embodiments, the substrate is a base for a product, such as custard powder, cake mix, bread mix, pancake mix or muffin mix which has been mixed with a liquid such as water, milk or a milk alternative. In some embodiments, the substrate is liquid cake mix, pancake mix or muffin mix. In some embodiments, the substrate is liquid or powdered pancake mix.

In some embodiments, the substrate is a plant-based substrate.

A ‘plant-based substrate’ as defined herein means any edible part of a plant or a fungus. For example, a fruit, vegetable, mushroom, nut, seed or pulse.

In some embodiments, the plant-based substrate is fresh i.e. substantially unprocessed, for example a harvested raw vegetable.

In some embodiments, the plant-based substrate is a fresh substrate that has been minimally processed to preserve the substrate without significantly changing the nutritional content.

For example by freezing (optionally with a prior step of blanching in boiling water) or canning, such as canning in natural juices, water or preserving solution (such as salt water).

In some embodiments, the plant-based substrate has been processed, for example by partial dehydration (such as raisins, or ‘ready to eat’ dried fruits such as ‘ready to eat’ apricots).

In some embodiments, the plant-based substrate has been highly processed, for example by substantial dehydration or freeze-drying such as to form granules or a powder. For example a powdered fruit smoothie, or a fruit powder.

In preferred embodiments, the substrate comprises no more than about 20 wt % plant-based substrate in powdered or granulated form, or no more than about 19 wt %, about 18 wt %, about 17 wt % about 16 wt %, about 15 wt, about 14 wt %, about 13 wt %, about 12 wt %, about 11 wt %, about 10 wt %, about 9 wt %, about 8 wt %, about 7 wt %, about 6 wt %, about 5 wt %, about 4 wt %, about 3 wt %, about 2 wt % or about 1 wt % in powdered or granulated form. In some preferred embodiments, the plant-based substrate is not in powdered or granulated form.

In preferred embodiments the plant-based substrate is fresh or a fresh product that has been frozen.

The vegetable may be any vegetable. Examples include carrot, beetroot, capsicum (also known as a pepper), cabbage, tomato, peas, broad beans, cabbage, aubergine, potato, yam, sweetcorn, broccoli, spinach; a cucurbit vegetable, such as squash, including butternut squash, pumpkin, cucumber, cauliflower, celeriac, celery, courgette or marrow; an allium vegetable such as onion, garlic, shallot, chive or scallion; or herbs or flavourants such as thyme, basil, oregano, parsley, chilli or dill; or any mixture of two or more vegetables. The types and combination of vegetables can be selected to give different flavours and/or textures. In some embodiments, the vegetable is one or more of red pepper, carrot, broccoli, spinach, squash, beetroot, parsnip, green pea, sweet potato and/or mushroom.

The fruit may be any fruit, for example one or more of apple, pear, orange, strawberries, blackberries, raspberries, redcurrants, banana, blackcurrants, blueberries, cranberries, persimmon, plum, peach, apricot, orange, mandarin, lemon, grapefruit, lime, mango, cherry, pineapple, kiwi, fig, papaya, starfruit, guava, pomegranate or grape; or any mixture of two or more fruits. The types and combination of fruit can be selected to give different flavours and/or textures.

In some embodiments, the plant-based substrate is not a cereal crop or does not comprise more than about 50 wt %, more than about 45 wt %, more than about 40 wt %, more than about 35 wt %, more than about 30 wt %, more than about 25 wt %, more than about 20 wt %, more than about 15 wt %, more than about 14 wt %, more than about 13 wt %, more than about 12 wt %, more than about 11 wt %, more than about 10 wt %, more than about 9 wt %, more than about 8 wt %, more than about 7 wt %, more than about 6 wt %, more than about 5 wt %, more than about 4 wt %, more than about 3 wt %, more than about 2 wt % or more than about 1 wt % of a cereal crop.

In some embodiments, the plant-based substrate does not comprise or is not one or more of wheat, maize, rice, barley, oats, millet, rye, sorghum, spelt, quinoa and/or buckwheat, or does not comprise more than about 50 wt %, more than about 45 wt %, more than about 40 wt %, more than about 35 wt %, more than about 30 wt %, more than about 25 wt %, more than about 20 wt %, more than about 15 wt %, more than about 14 wt %, more than about 13 wt %, more than about 12 wt %, more than about 11 wt %, more than about 10 wt %, more than about 9 wt %, more than about 8 wt %, more than about 7 wt %, more than about 6 wt %, more than about 5 wt %, more than about 4 wt %, more than about 3 wt %, more than about 2 wt % or more than about 1 wt % of one or more of wheat, maize, rice, barley, oats, millet, rye, sorghum, spelt, quinoa and/or buckwheat.

In some embodiments, the plant-based substrate does not comprise or is not potato, or does not comprise more than about 50 wt %, more than about 45 wt %, more than about 40 wt %, more than about 35 wt %, more than about 30 wt %, more than about 25 wt %, more than about 20 wt %, more than about 15 wt %, more than about 14 wt %, more than about 13 wt %, more than about 12 wt %, more than about 11 wt %, more than about 10 wt %, more than about 9 wt %, more than about 8 wt %, more than about 7 wt %, more than about 6 wt %, more than about 5 wt %, more than about 4 wt %, more than about 3 wt %, more than about 2 wt % or more than about 1 wt % potato.

The fungus may be a mushroom or yeast extract.

The nut may be any nut, for example one or more of almonds, pecans, hazelnuts, peanuts, walnuts, cashew, brazil or pine nuts. The types and combination of nut can be selected to give different flavours and/or textures.

The seed may be any seed, for example one or more of sunflower, sesame, nigella or pumpkin seeds. The types and combination of seed can be selected to give different flavours and/or textures.

The pulse may be any pulse, for example one or more of chickpeas, soya beans, fava beans, turtle beans, butter beans, kidney beans, lentils; or any mixture of two or more pulses. The types and combination of pulse can be selected to give different flavours.

In some embodiments the plant-based substrate comprises or consists of one or more fruits, vegetables, nuts, seeds, fungi and/or pulses. In some embodiments, the plant-based substrate comprises or consists of up to 20 types of fruits, vegetables, nuts, seeds, fungi and/or pulses; or up to 18, up to 15, up to 12, up to 10, up to 9, up to 8, up to 7, up to 6, up to 5, up to 4, or up to 3 types or fruits, vegetables, nuts, seeds, fungi and/or pulses; or 2 types of fruits, vegetables, nuts, seeds, fungi and/or pulses; or a single type of fruit, vegetable, nut, seed, fungi or pulse.

In some embodiments, the plant-based substrate comprises, consists essentially of, or consists of one or more fruits, vegetables and/or one or more fungus. In some embodiments, the plant-based substrate comprises, consists essentially of, or consists of one or more vegetables and/or one or more fungus. In preferred embodiments the plant-based substrate may be selected from beetroot, parsnip, sweet potato, mushroom and capsicum or any combination thereof.

In some embodiments, the substrate does not comprise a non-plant based protein, i.e. a protein derived from any source other than a plant or fungus. In some embodiments, the substrate does not comprise an animal protein. In some embodiments, the substrate does not comprise egg or a component of egg.

In some embodiments, the plant-based substrate does not comprise isolated plant protein, i.e. protein from a plant-based source which has been extracted or isolated, for example for use for its proteinaceous properties, such as rice protein, soy protein or pea protein.

In some embodiments, the substrate does not comprise a dairy product, or a constituent or product derived from a diary product. In some embodiments, the substrate does not comprise milk, yogurt, butter or cheese.

In some embodiments, the substrate is pre-processed. For example, the substrate may be salsa; a soup, such as a vegetable or gazpacho soup; or a juice, such as a fruit or vegetable juice, or a smoothie such as a fruit smoothie.

Gazpacho soup is a vegetable based soup of Spanish cuisine. It typically comprises tomato (typically about 55-65%), capsicum (typically about 12%), cucumber (typically about 12%) and onion (typically about 9%). Salsa is a vegetable based dip of Mexican cuisine. It typically comprises about 50% tomato, optionally capsicum, and onion. Any product described as gazpacho soup or salsa or maybe used as a substrate in the present disclosure.

### Processing

In optional step 2 of the method the substrate is processed.

The need for processing may depend on the substrate. For example, soft fruits or vegetables (e.g. berries, tomatoes) may not require cooking; nuts such as pine nuts or berries such as blackcurrants may not need to be reduced in size. Pre-processed substrates, such as salsa, a soup or juice may not require processing.

In some embodiments wherein the substrate is frozen, such as ice cream, the substrate is melted.

In some embodiments wherein the substrate is a plant-based substrate, the plant-based substrate is cooked or partially cooked, for example in order to soften or break-down some or all of the cell walls.

In some embodiments the plant-based substrate is partially cooked until some softening occurs but without any or any substantial loss of colour. In some embodiments the plant-based substrate may be steam cooked at a temperature of at least 90° C. or at least 100° C., for example up to 250° C., for a period of from 2 to 15 minutes, optionally from 5 to 10 minutes, optionally from 8 to 12 minutes to blanche or at least partly cook the substrate.

Additionally or alternatively, in some embodiments the substrate, such as the plant-based substrate, is reduced in size, for example by dicing, grating, shredding or pureeing.

Where processing is undertaken, it is not required to process the substrate until a smooth or lump-free puree is achieved; particles or pieces of substrate maybe retained.

In some embodiments processing reduces the substrate in size, for example, to provide pieces of fruit, vegetable, seed, nut, fungus or pulse. The size of the pieces may depend upon the substrate. For example, dense substrates, such as nuts, may be comminuted into smaller sized pieces than less dense substrates, such as fresh capsicum. The size and density of the pieces of substrate can affect their location within the matrix of the finished product as a person skilled in the field would understand: suspension of pieces throughout the batter typically results in dispersion of pieces throughout the matrix of the finished snack product, whereas sedimentation of pieces within the batter can result in accumulation of the pieces at the base of the finished snack product. The substrate may therefore be reduced to a size to optimize location of the pieces throughout the matrix of the finished product. For example, almonds may be reduced in size to about 3 mm².

In some embodiments the substrate may be processed to provide a ‘rough’ puree which comprises pieces of the substrate. In some such embodiments the pieces of the substrate are no more than about 5 mm², no more than about 4.5 mm², not more than about 4 mm², or no more than about 3 mm²; or about 2.5, 3 or 3.5 mm² in size.

In some embodiments the substrate may be processed to provide a smooth puree. In some embodiments wherein the substrate is a plant-based substrate, the substrate may be processed to provide a juice, for example by pureeing and then filtration.

In preferred embodiments wherein the substrate is a plant-based substrate, the plant-based substrate undergoes limited or minimal processing prior to incorporation with the other ingredients of the batter. For example, if the plant-based substrate consists of fresh carrot, the carrot maybe partially cooked (so just soft or ‘al dente’) and then pureed or partially pureed to provide a ‘rough’ puree. Limiting processing helps to retain the colour, flavours and nutritional attributes of the plant substrate.

### Additional Ingredients

In step 3 of the method additional ingredients are selected.

An ingredient may be added to increase viscosity of the batter. The ingredient may be a fibrous material such as apple or citrus fibre and/or a gum such as xanthan or locus bean gum or gum Arabic.

Providing a batter with an increased viscosity helps to keep the substrate and, if present, pieces of the substrate, in suspension as bubbles form during expansion. This aids creation of an evenly expanded product comprising a matrix composed substantially of the substrate, with pieces of the substrate, where present, distributed within the matrix.

A further additional ingredient is starch. The addition of starch increases viscosity of the batter. In addition, the starch contributes to achieving the expanded nature of the snack, due to its ability to gelatinise and set rapidly upon dehydration.

In some such embodiments the starch is pre-gelatinized. In some such embodiments the starch is pre-gelatinized waxy maize starch, pre-gelatizined corn starch, pre-gelatizined tapioca or pre-gelatinized potato starch. In some embodiments, the starch is not native starch.

A further additional ingredient is an emulsifier. In some embodiments, the emulsifier is amphipathic. In some embodiments, the emulsifier is one or more of lecithin or related edible phospholipids; a distilled monoglyceride made from edible, fully hydrogenated palm based oil such as Dimodan® (a distilled monoglyceride made from edible, refined hydrogenated palm oil; aquafaba; or an emulsifier derived from a protein, such as canola or flaxseed protein. The lecithin may be derived from, for example sunflower, soy or eggs. In some embodiments, the emulsifier is not derived from a protein. In preferred embodiments, the emulsifier is not derived from egg.

Due to its amphipathic nature, the emulsifier tends to aggregate as a bilayer on the surface of bubbles as they form, and so helps to control the size of the bubbles created during expansion.

In some embodiments, further additional ingredients maybe selected, for example ingredients to provide sensory properties such as seasonings, flavourings and dry inclusions, for example salt, pepper, cinnamon, mint, lemongrass, chilli, onion or garlic powder or granules, dried herbs, or pre-prepared seasoning mixtures such as those intended to impart a particular flavour or sensation, for example a Thai, Chinese, Japanese, Indian, curry, or unami sensation or flavour; or liquid inclusions such as vanilla, almond or peppermint extract or essence; or sweeteners such as syrup, for example maple syrup, honey or agave.

Such ingredients may enhance the flavour of the product without changing the essential structure or texture characteristics of the product, or the manufacturing process discussed herein. It is preferred not to use any artificial additives, such as artificial flavourings or colourants. Typically additional ingredients have a size no greater than 5 mm², 4 mm² or 3 mm².

In some embodiments, the batter may further comprise cheese. The cheese may be a soft cheese, such as feta or goats cheese; and/or hard cheese, such as Manchego. The cheese may be fresh or dried. In embodiments, the batter may comprise up to or about 35 wt % cheese, or about 30 wt %, about 25 wt %, about 30 wt %, about 25 wt %, about 20 wt % about 15 wt %, about 10 wt %, about 5 wt % or about 2 wt % cheese. Typically the cheese is grated, powdered or otherwise reduced in size, so that individual particles or pieces have a size no greater than 5 mm², 4 mm² or 3 mm². Addition of cheese in the amounts given may enhance the flavour of the product but does not change the essential structure or texture characteristics of the product, or the manufacturing process discussed herein.

In some embodiments wherein the substrate is a plant-based substrate, the batter may further comprise yoghurt, cream, milk or cream cheese. In some embodiments the batter comprises cream cheese. In some embodiments the batter comprises up to or about 4% cream cheese. Addition of cream cheese in this amount does not change the essential structure or texture characteristics of the product, or the manufacturing process discussed herein but may enhance the flavour of the product.

In some embodiments, the batter may further comprise oil or fat, such as a vegetable, sunflower, such as high oleic sunflower oil (HOSO), rapeseed or coconut oil. In such embodiments, the batter comprises up to 0.5 wt %, up to 1 wt %, up to 1.2 wt %, up to 1.4 wt %, up to 1.5 wt %, up to 1.6 wt %, up to 1.7 wt %, up to 1.8 wt %, up to 1.9 wt % up to 2 wt % or about 2 wt % added oil or fat. In some embodiments, the batter comprises no added oil or fat. References herein to ‘added oil or fat’ mean any oil or fat that has been added to the batter or finished product, i.e. oil or fat that is added beyond oil or fat that is naturally present in the ingredients of the batter.

In some embodiments, the batter does not comprise a leavening or raising agent such as yeast, sodium bicarbonate (baking soda) or baking powder.

In some embodiments, the batter does not comprise one or more of ammonium carbonate, ammonium bicarbonate, potato protease inhibitors, calcium azide, maltodextrin or pectin.

In some embodiments, the batter does not comprise egg or any component derived from egg, or from an egg substitute, such as chia or flax seeds.

In some embodiments, the batter does not comprise isolated plant protein, i.e. protein from a plant-based source which has been extracted or isolated, for example for use for its proteinaceous properties, such as rice protein, soy protein or pea protein. In some embodiments, the batter does not comprise one or more of rice protein, soy protein or pea protein.

In some embodiments, the batter does not comprise a non-plant based protein, i.e. a protein derived from any source other than a plant or fungus. In some embodiments, the batter does not comprise an animal derived protein.

In some embodiments, the batter does not comprise a dairy product, or a constituent or product derived from a diary product. In some embodiments, the substrate does not comprise milk, yogurt, butter or cheese.

### Addition of Water & Amounts of Ingredients in the Batter

In step 4 of the method water may optionally be added to the substrate and additional ingredients.

References herein to ‘added water’ means any water that has been added to the other batter ingredients, i.e. water that is added beyond the water that is naturally present in the other ingredients of the batter.

The requirement for addition of water depends upon the moisture content of the other ingredients in the batter. In some embodiments, addition of water is not required, for example, where the substrate is milk, a milk alternative, soup, a smoothie or juice.

Typically, a batter comprising a plant-based substrate and added water according to an embodiment of the present disclosure comprises the following:
(i) 30-46 wt % plant-based substrate;
(ii) 8-23 wt % starch;
(iii) 0.5-2.5 wt % emulsifier;
(iv) 0.0-1.0 wt % salt
(v) 30-50 wt % added water.

Based on the weight of the batter; the total ingredients combined being 100 wt %.

A typical batter which does not comprise added water according to an embodiment of the present disclosure may comprise the following:
(i) 80-90% plant-based substrate such as a juice or a plant based soup, such as a gazpacho soup; or a non-plant based substrate such as milk;
(ii) 8-12 wt % starch;
(iii) 0.3-1.5 wt % emulsifier.

Based on the weight of the batter; the total ingredients combined being 100 wt %.

An example batter which does not comprise added water according to an embodiment of the present disclosure may comprise the following:
(iv) 88.8 wt % plant-based substrate such as a juice or a plant based soup, such as a gazpacho soup;
(v) 11.9 wt % starch;
(vi) 1.29 wt % emulsifier.

A second example batter which does not comprise added water according to an embodiment of the present disclosure may comprise the following:
(i) 86.3 wt % substrate such as flavoured milk;
(ii) 11.9 wt % starch;
(iii) 1.29 wt % emulsifier
(iv) 0.5% salt.

In embodiments comprising a plant-based substrate, the batter may comprise about 20-about 95 wt % of the plant-based substrate based on the total weight of the batter. In preferred embodiments, the batter comprises about 20-about 90 wt % of the plant-based substrate based on the total weight of the batter, or about 21-about 87 wt % of the plant-based substrate based on the total weight of the batter, about 22-about 87 wt % of the plant-based substrate based on the total weight of the batter or about 20-about 85 wt % of the plant-based substrate based on the total weight of the batter.

In some embodiments, the batter may comprise up to about 94 wt %, up to 92 Wt %, up to 90 wt %, up to 88 wt %, up to 85 wt %, up to 83 wt %, up to 80 wt %, up to 78 wt %, up to 75 wt %, up to 73 wt %, up to 70 wt %, up to 68 wt %, up to 65 wt %, up to 64 wt %, up to 63 wt %, up to 62 wt %, up to 61 wt %, up to 60 wt %, up to 59 wt %, up to 58 wt %, up to 57 wt %, up to 56 wt %, up to 55 wt %, up to 54 wt %, up to 53 wt %, up to 52 wt %, up to 51 wt %, 50 wt %, up to 49 wt %, up to 48 wt %, up to 47 wt %, up to 46 wt %, up to 45 wt %, up to 44 wt %, up to 43 wt %, up to 42 wt %, up to 41 wt %, up to 40 wt %, up to 39 wt %, up to 38 wt %, up to 37 wt %, up to 36 wt %, up to 35 wt %, up to 34 wt %, up to 33 wt %, up to 32 wt %, up to 31 wt %, up to 30 wt %, up to 29 wt %, up to 28 wt %, up to 27 wt %, up to 26 wt %, up to 25 wt %, up to 24 wt %, up to 23 wt %, or up to 22 wt % of the plant-based substrate based on the total weight of the batter.

It may alternatively be said that the batter comprises at least about 20 wt % of plant-based substrate based on the total weight of the batter or at least about 21 wt %, at least about 22 wt %, at least about 23 wt %, at least about 24 wt %, at least about 25 wt %, at least about 26 wt %, at least about 27 wt %, at least about 28 wt %, at least about 29 wt %, at least about 30 wt %, at least about 31 wt %, at least about 32 wt %, at least about 33 wt %, at least about 34 wt %, at least about 35 wt %, at least about 36 wt %, at least about 37 wt %, at least about 38 wt %, at least about 39 wt %, at least about 40 wt %, at least about 41 wt %, at least about 42 wt %, at least about 43 wt %, at least about 44 wt %, at least about 45 wt %, at least about 46 wt %, at least about 47 wt %, at least about 48 wt %, at least about 49 wt %, at least about 50 wt %, at least about 51 wt %, at least about 52 wt %, at least about 53 wt %, at least about 54 wt %, at least about 55 wt %, at least about 56 wt %, at least about 57 wt %, at least about 58 wt %, at least about 59 wt %, at least about 60 wt %, at least about 65 wt %, at least about 68 wt %, at least about 70 wt %, at least about 72 wt %, at least about 75 wt %, at least about at least about 78 wt %, at least about 80 wt %, at least about 82 wt %, at least about 85 wt %, at least about 88 wt %, at least about 90 wt %, at least about 91 wt %, at least about 92 wt %, at least about 93 wt %, at least about 94 wt % or at least about 95 wt % of the plant based substrate based on the total weight of the batter.

In some embodiments wherein the batter comprises added water the batter may comprise 20-50 wt % plant based substrate, or 25-48 wt %, 28-47 wt %, or 29-47 wt % plant-based substrate.

In some embodiments wherein the batter does not comprises added water the batter may comprise 50-95 wt % plant based substrate, or 55-95 wt %, 60-95 wt %, 65-95 wt %, 70-93 wt %, 75-93 wt %, 80-92 wt %, 85-92 wt % or 88-92 wt % plant-based substrate.

The batter may comprise about 8-28 wt % added starch based on the total weight of the batter. ‘Added starch’ means starch that is added to the other batter ingredients, i.e. starch that is added beyond the starch that is naturally present in the other ingredients of the batter. The amount of starch added to the batter may depend upon the substrate used. For example sweet potato contains more starch than broccoli. This would be understood by the skilled person.

In some embodiments, the batter may comprise about 5-25 wt % added starch, about 5-20 wt % or about 8-25 wt % added starch, or about 9-23 wt % added starch, about 9-20 wt % added starch, about 9-18 wt % added starch, about 9.5-15 wt % added starch or about 10-12.5 wt % added starch.

Alternatively it may be said that in some embodiments, the batter may comprise up to about 28 wt %, up to 27 wt %, up to 26 wt %, up to 25 wt %, up to 24 wt % up to 23 wt %, up to 22 wt %, up to 21 wt %, up to 20 wt %, up to 19 wt %, up to 18 wt %, up to 17 wt %, up to 16 wt %, up to 15 wt %, up to 14 wt %, up to 13 wt %, up to 12 wt %, up to 11 wt %, up to 10 wt %, up to 9 wt % or up to 8 wt % added starch based on the total weight of the batter. It may alternatively be said that the batter comprises at least about 8 wt % added starch based on the total weight of the batter or at least about 9 wt %, at least about 10 wt %, at least about 11 wt %, at least about 12 wt %, at least about 13 wt %, at least about 14 wt %, at least about 15 wt %, at least about 16 wt %, at least about 17 wt %, at least about 18 wt %, at least about 19 wt %, at least about 20 wt %, at least about 21 wt %, at least about 22 wt %, at least about 23 wt %, at least about 24 wt %, at least about 25 wt %, at least about 26 wt %, or at least about 27 wt % added starch based on the total weight of the batter.

In some preferred embodiments, the batter comprises between about 8 and 25 wt % added starch.

In some embodiments, the batter comprises at least about 7.5 wt %, at least about 8 wt % or at least about 8.5 wt % added starch. In some embodiments, the batter comprises no more than about 27.5 wt %, no more than about 27 wt %, no more than about 26 wt %, no more than about 26.5 wt %, no more than about 25.5 wt %, no more than 25 wt % or no more than about 24.5 wt % added starch.

The batter may comprise about 0.3-2.8 wt % added emulsifier based on the total weight of the batter. ‘Added emulsifier’ means emulsifier that is added to the other batter ingredients, i.e. emulsifier that is added beyond any emulsifier that is naturally present in the other ingredients of the batter.

In some embodiments, the batter may comprise about 0.3-2.5 wt % added emulsifier, or about 0.5-2.5 wt %, 0.3-2.2 wt %, about 0.4-2.1 wt %, about 0.5-2 wt % added emulsifier.

In some embodiments, the batter may comprise up to about 0.4 wt %, up to 0.5 wt %, up to 0.6 wt %, up to 0.7 wt %, up to 0.8 wt %, up to 0.9 wt %, up to 1.0 wt %, up to 1.1 wt %, up to 1.2 wt %, up to 1.3 wt %, up to 1.4 wt %, up to 1.5 wt %, up to 1.6 wt %, up to 1.7 wt %, up to 1.8 wt %, up to 1.9 wt %, up to 2.0 wt %, up to 2.1 wt %, up to 2.2 wt %, up to 2.3 wt %, up to 2.4 wt % up to 2.5 wt %, up to 2.6 wt %, up to 2.7 wt % or up to 2.8 wt % added emulsifier based on the total weight of the batter.

It may alternatively be said that the batter comprises at least about 2.5 wt % of added emulsifier based on the total weight of the batter or at least about 2.4 wt %, at least about 2.3 wt %, at least about 2.2 wt %, at least about 2.1 wt %, at least about 2.0 wt %, at least about 1.9 wt %, at least about 1.8 wt %, at least about 1.7 wt %, at least about 1.6 wt %, at least about 1.5 wt %, at least about 1.4 wt %, at least about 1.3 wt %, at least about 1.2 wt %, at least about 1.1 wt %, at least about 1.0 wt %, at least about 0.9 wt %, at least about 0.8 wt %, at least about 0.7 wt %, at least about 0.6 wt %, at least about 0.5 wt %, at least about 0.4 wt % or at least about 0.3 wt % added emulsifier based on the total weight of the batter.

The batter may comprise about 25-55 wt % added water based on the total weight of the batter. In some embodiments, the batter may comprise up to 55 wt %, up to 54 wt %, up to 53 wt %, up to 52 wt %, up to 51 wt %, up to 50 wt %, up to 49 wt %, up to 48 wt %, up to 47 wt %, up to 46 wt %, up to 45 wt %, up to 44 wt %, up to 43 wt %, up to 42 wt %, up to 41 wt %, up to 40 wt %, up to 39 wt %, up to 38 wt %, up to 37 wt %, up to 36 wt %, up to 35 wt %, up to 34 wt %, up to 33 wt %, up to 32 wt %, up to 31 wt %, up to 30 wt %, up to 29 wt %, up to 28 wt %, up to 27 wt %, or up to 26 wt % added water based on the total weight of the batter. It may alternatively be said that the batter comprises at least about 25 wt % added water based on the total weight of the batter or at least about 26 wt %, at least about 27 wt %, at least about 28 wt %, at least about 29 wt %, at least about 30 wt %, at least about 31 wt %, at least about 32 wt %, at least about 33 wt %, at least about 34 wt %, at least about 35 wt %, at least about 36 wt %, at least about 37 wt %, at least about 38 wt %, at least about 39 wt %, at least about 40 wt %, at least about 41 wt %, at least about 42 wt %, at least about 43 wt %, at least about 44 wt %, at least about 45 wt %, at least about 46 wt %, at least about 47 wt %, at least about 48 wt %, at least about 49 wt %, at least about 50 wt %, at least about 51 wt %, at least about 52 wt %, at least about 53 wt %, or at least about 54 wt % added water based on the total weight of the batter.

### Mixing

In step 5 of the method the ingredients of the batter are mixed. Mixing is carried out to incorporate the ingredients and provide a homogenous or substantially homogenous batter, so that pieces of substrate, if present, are suspended throughout the batter.

It is not necessary to mix the batter so that any pieces of substrate within the batter are broken down significantly or pureed.

Any suitable mixer may be used to mix the ingredients of the batter. For example, the batter may be mixed by hand using a spoon or whisk, or by a hand blender, electric beaters, food processor or an industrial mixer.

It is not necessary to mix the batter so as to significantly aerate or foam the batter in order to achieve expansion upon subsequent microwave dehydration. However, if desired the batter can be foamed in a syphon, by adding a compressed gas such as CO₂, NO or NO₂. Foaming does not result in any significant additional expansion upon subsequent microwave dehydration. In preferred embodiments, the batter is not intentionally foamed or aerated, for example by the addition of a compressed gas.

The resultant batter has a moisture content of from about 55 to 90 wt % based on the weight of the batter. In some embodiments, the moisture content of the batter is about 60 to 90 wt %, or about 65 to 90 wt %, about 70 to 90 wt %, about 75 to 90 wt %, about 80 to 90 wt %, about 81 to 90 wt %, or about 82 to 90 wt %. In some embodiments, the moisture content of the batter is at least about 60 wt %, at least about 65 wt %, at least about 70 wt %, at least about 75 wt %, at least about 76 wt %, at least about 77 wt %, at least about 78 wt %, at least about 79 wt %, or at least about 80 wt %. In some embodiments, the moisture content of the batter is about 58 to about 89 wt %, or about 60 to about 88 wt %, about 65 to about 85 wt %, about 70 to about 85 wt %, about 75 to about 82 wt %, about 78 to about 82 wt %, or about 79 to about 81 wt %. In some embodiments, the moisture content of the batter is about 75 wt %, about 76 wt %, about 77 wt %, about 78 wt %, about 79 wt %, about 80 wt %, about 81 wt % or about 82 wt % based on the weight of the batter.

Viscosity of the batter may be measured by any suitable means. For example, using a viscometer, such as a Bostwick consistometer; and/or using a texture analyser, which quantifies the force required to compress a batter by 25 mm (the greater the force required, the more viscous the batter).

A batter which provides an expanded product according the present disclosure typically travels between about 3 cm to about 11 cm in 1 minute on a Bostwick consistometer and/or requires a force of between about 70 and about 250 g to compress it to 25 mm in a texture analyser.

The viscosity of the batter may vary depending upon the starch content of the batter, which can be affected by the substrate selected and/or the amount of starch added to the batter.

In some embodiments, a batter which travels between about 8 cm to about 2.5 cm in 1 minute on a Bostwick consistometer provides an expanded product according the present disclosure. In some embodiments where the batter comprises a high liquid:starch ratio the batter may travel about 7.8 cm in 1 minute on a Bostwick consistometer; whilst a higher viscosity batter (for example comprising a higher level of starch) may travel about 2.7 cm in 1 minute on a Bostwick consistometer.

Moisture content and viscosity of the batter contribute to achieving the expanded nature of the snack food product upon microwave dehydration. The use of a microwave is thought to cause a rapid increase in the temperature of the water within the batter, which increases internal pressure resulting in the formation of bubbles within the batter that give rise to the expanded, textured architecture of the product. Lower viscosity tends to result in a lighter, more expanded texture, however, a batter which has a high moisture content and thus a low viscosity can result in a loss of bubble structure within the product upon microwave dehydration. This is thought to be because the batter ingredients do not solidify sufficiently and/or quickly enough to prevent so called ‘boil out’, where the water within the batter evaporates away and is not trapped by bubbles within the product.

### Dispensing and Mould

In step 6 of the method the batter is dispensed into a mould suitable for use in a microwave.

The mould material is preferably substantially non-absorbing of microwave energy. In some embodiments, the mould material heats less than 10° C. in 60 secs in a 800-1000 W domestic microwave oven on 100% power when it is heated alone.

The mould comprises one or more compartments into which the batter is dispensed.

The type and configuration of compartments in the mould contributes to achieving the expanded nature of the snack food product upon microwave dehydration. The viscosity of the batter decreases as it is heated during the dehydration step. As a result, in the absence of a mould, the batter spreads, resulting in a randomly shaped, thin product with low expansion due to its thickness.

The size of the mould compartment may be varied according to the desired size of the resultant product. In some embodiments, mould compartments have a depth of about 2.8, about 2.7, about 2.6, about 2.5, about 2.4, about 2.3, about 2.2, about 2.1, about 2.0, about 1.9, about 1.8, about 1.7, about 1.6 or about 1.5 cm.

The shape of the mould compartment may be varied according to the desired shape of the resultant product. In some embodiments, the compartments define or approximately define a regular 3D shape, such as a cube or cuboid. Alternatively, the mould compartments could be, for example half-sphere shaped, or novelty shaped such as crescent, heart, leaf or animal shaped.

In some cube shaped embodiments, the dimensions of the mould compartments are about 2.5 cm (h) by about 2.5 cm (1) by about 2.5 cm (d).

In some embodiments, each mould compartment contains between about 1.8 and about 8.5 g of batter. In some embodiments using a mould with compartments which are cube or cuboidal shaped or approximately cube or cuboidal shaped, each compartment contains about 4 to about 8 g of batter or about 4.5 g to about 7-5 g, about 5 g to about 7-5 g, about 5.5 g to about 7 g, or about 6 g to about 7 g, of batter, or about 4 g, about 4.5 g, about 5 g, about 5.5 g, about 6 g, about 6.5 g, about 7 g or about 7-5 g of batter.

In some embodiments using a mould with compartments which are not regular and/or shallower in shape, such as half sphere or heart shaped, each compartment contains about 1.8 g to about 4 g of batter or about 1.9 g to about 3.8 g, about 2 g to about 3-5 g or about 2 g to about 3.6 g or about 2 g to about 3 g batter, or about 2 g, about 2.5 g, about 3 g, or about 3.58 of batter.

In some preferred embodiments, mould compartments are separated such that there is negligible risk of arcing between compartments into which batter has been dispensed and/or the compartments are at least 5 mm apart. Compartments may be arranged in a toroidal geometry with one or more empty (i.e. non-batter containing) compartments in the centre. Configuration in a toroid annulus can be advantageous as it allows optimal loading of batter whilst maintaining a distance of at least 5 mm between compartments and reducing the risk of arcing between batter-containing compartments.

In some alternative embodiments where a mould is used that has multiple compartments which are not significantly separated (i.e. just have a dividing wall between the compartments), batter may be loaded into alternate compartments, so the filled mould comprises empty (i.e. non-batter containing) compartments. Configuration in this way can be advantageous as it maintains a distance of at least 5 mm between batter-containing compartments and thus reduces the risk of arcing between these compartments.

In other alternative embodiments where a mould is used that has multiple compartments which are not significantly separated (i.e. just have a dividing wall between the compartments), batter may be loaded into every compartment, so the filled mould does not comprise empty (i.e. non-batter containing) compartments. This arrangement maybe preferable where the product does not undergo a finishing step.

### Microwave Dehydration

In step 7 of the method the filled mould is subjected to microwave dehydration. The microwave dehydration step may be carried out by conveying the mould through a multi-zone flatbed microwave cooking apparatus. Alternatively, a catering microwave (typically having a full power setting of 2600 W and a half power setting of 1300 W; or a full power setting of 1500 W and a half power/medium setting of 750 W) or a domestic (800-100 W or 800-1300 W power) microwave can be used.

The microwave dehydration step produces a product having a moisture content of from about 2-20 wt % based on the weight of the product. In some embodiments, the microwave dehydration step produces a product having a moisture content of about 2 wt %, about 3 wt %, about 4 wt %, about 5 wt %, about 6 wt %, about 7 wt %, about 8 wt %, about 9 wt %, about 10 wt %, about 11 wt %, about 12 wt %, about 13 wt %, about 14 wt %, about 15 wt %, about 16 wt %, about 17 wt %, about 18 wt %, or about 19 wt % based on the weight of the product. In some preferred embodiments, the moisture content of the dehydrated product is about 8-15 wt %, or 10-13 wt % or about 12% based on the weight of the product.

The time of exposure to microwaves and power density of the microwaves required to achieve a product having the require moisture content may vary, depending upon the moisture content of the batter, and the type of microwave used.

If an industrial microwave is used, typically, the microwave dehydration step is carried out using a power density setting of 15-50 kW for about 72 seconds. This may be achieved in multiple steps, for example using a power density setting of 47 kW for 25 seconds, followed by a power density setting of 35 kW for 25 seconds followed by a power density setting of 17 kW for 22 seconds.

If a catering microwave is used, typically, the microwave dehydration step is carried out on a power setting of 2600 W for a period of about 2 minutes followed by 1300 W for a period of about 2 minutes.

In some embodiments wherein a finishing step is not desired, a domestic microwave with a power setting of 750-800 W, optionally set to ‘medium’ (600 W), maybe used for the microwave dehydration step. In some such embodiments, multiple short (30 s to 1 minute) microwave dehydration steps may be carried out, to give a total microwave dehydration time of between about 4 and 6 minutes or 5 and 6 minutes. For example, microwave dehydration may be carried out for a period of 1 min, repeated 3 further times to give a total dehydration time of 4 minutes. The products may then optionally be visually inspected and if needed, microwave dehydration carried out for a further period of 30 seconds followed by optional visual inspection, and if necessary, a further period of 30 seconds. The shorter (30 s) microwave dehydration time intervals may help ensure that the products do not overcook or burn.

In some embodiments, no additional steps are required prior to the microwave dehydration step, for example, it is not necessary to chill or partially dehydrate the batter before dehydrating in the microwave.

After the microwave dehydrating step, the dehydrated snack food product comprises an expanded matrix composed substantially of the plant-based substrate. If the substrate comprised pieces, the pieces may be visible within the matrix. It is the dehydration step that results in the expanded product, rather than any subsequent finishing step.

In some preferred embodiments, the snack food product does not undergo a finishing step. In such embodiments, the microwave dehydration step is sufficient to lower the moisture content of the product to the level desired for a final product.

### Finishing

In step 8, the dehydrated snack food product is removed from the mould and may optionally be subjected to a finishing step. The finishing step lowers the moisture content of the product but does not fundamentally change the microstructure of the product.

In preferred embodiments, the finishing step does not involve frying.

In some embodiments, the finished step is a baking step, for example in a hot air convection oven, to produce a baked snack food product having a moisture content of from about 2-10 wt % based on the weight of the product. In some embodiments, the finishing step produces a product having a moisture content of about 2 wt %, about 3 wt %, about 4 wt %, about 5 wt %, about 5.5 wt %, about 6 wt %, about 6.5 wt %, about 7 wt %, about 7.5 wt %, about 8 wt %, about 8.5 wt %, about 9 wt %, about 9.5 wt % or about 10 wt % based on the weight of the product.

The oven temperature and length of the baking time required to achieve a product having the required moisture content may vary, depending upon the moisture content of the dehydrated product.

Typically, the baking step is carried out at an oven temperature of from 50-200° C. for a period of 10 to 30 minutes. In some embodiments, the hot air convection cooking is carried out at an oven temperature of about 100-120° C. for a period of 12 to 22 minutes.

### Finished Product

After the finishing step, the snack food product comprises an expanded, essentially rigid matrix composed substantially of substrate content, for example plant-based content. If the substrate comprised pieces, the pieces may be visible within the matrix. For example, where the substrate was a pancake or muffin comprising fruit or chocolate pieces; or the substrate was a plant-based substrate that comprised pieces, for examples, pieces of fruit, vegetable or nut, the pieces may be visible within the matrix.

By ‘substrate content’ is meant the content derived from the substrate following the dehydration step and any finishing steps. So by ‘plant based content’ is meant the content derived from the plant-based substrate following the dehydration and any finishing steps.

In some embodiments, the snack food product has a substrate content of from about 8 to about 87 wt % based on the weight of the snack food product. In some embodiments, the snack food product has a substrate content of from about 15 to about 87 wt %. In some embodiments, the snack food product has a substrate content of from about 35 to about 87 wt %, from about 36.5 to about 87 wt %, from about 40 to about 87 wt %, from about 45 to about 87 wt %, from about 45 to about 87 wt %, from about 50 to about 87 wt %, from about 55 to about 87 wt %, from about 60 to about 87 wt %, from about 65 to about 87 wt %, or from about 68 to about 87 wt %.

The substrate content of the snack food may vary according to the type of substrate used in the batter.

For example, where the substrate is a powdered pancake mix, the resultant snack food product may have a substrate content of about 37 wt % based on the weight of the snack food product and a moisture content of about 4 wt % based on the weight of the snack food product. As a further example, where the substrate is vanilla ice cream, the snack food product may have a substrate content of about 60 wt % based on the weight of the product, and a moisture content of about 4 wt % based on the weight of the snack food product.

In some embodiments wherein the substrate is a plant-based substrate, the snack food product has a plant-based content of from about 15 wt % to about 70 wt % based on the weight of the snack food product, or from about 30 wt % to about 87 wt % or about 35 wt % to about 87 wt %, or about 36 wt % to 87 wt % or about 37 wt % to about 87 wt %, or about 35 wt % to about 70 wt %, or 36 wt % to about 70 wt %, or about 36 wt % to about 56 wt %, or about 37 wt % to about 55.5 wt % based on the weight of the snack food product.

For embodiments comprising a plant-based substrate, the plant-based content in the snack food may vary according to the type of plant-based substrate used in the batter. For example, a batter comprising capsicum puree as the plant based substrate (as per Examples 2, 7 and 8) provides a dehydrated and finished product having a moisture content of about 4 wt % comprising about 19.5 wt % plant-based content based on the weight of the product. Such a product may comprise about 69.7 wt % starch based on the weight of the product.

As a further example, a batter comprising green pea puree as the plant-based substrate and about 8% starch provides a dehydrated and finished product having a moisture content of about 4 wt % comprising about 66 wt % plant-based content based on the weight of the product. Such a product comprises about 24 wt % starch based on the weight of the product.

As a further example, a batter comprising Gazpacho soup as the plant-based substrate provides a dehydrated and finished product having a moisture content of about 4 wt % comprising about 53 wt % plant-based content based on the weight of the product. Such a product comprises about 34 wt % starch based on the weight of the product.

The finished product has a crisp structure, typically associated with snack food products, in which the matrix has an evenly expanded structure comprising cellular voids, that is light and crispy. The expanded structure is achieved without the use of frying. As such, the present disclosure provides an expanded, non-fried snack food product.

The microstructure of the finished product may be analysed and characterised using microscopy and calculations as described below.

In the analysis, finished products are fractured at a statistically significant number of locations over the surface area of the product to reveal the internal microstructure in cross-section. The cross-section is analysed using microscopy, preferably scanning electron microscopy (SEM), although light microscopy may alternatively be used.

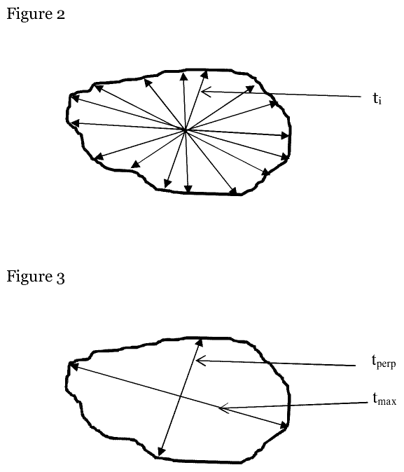

As shown in FIG. 2, a given cellular pore is measured to determine the cellular pore size dimension by taking a statistically significant number of measurements of the distance between opposite edges of the cellular pore extending through a central point, i.e. the width of the cellular pore. For example, there may be eight measurements of the width tᵢ of the cellular pore as shown in FIG. 2. Referring to FIG. 2, for any given cellular pore the size Φ of the cellular pore is preferably calculated as an average value of the width tᵢ of the cellular pores, and therefore in this embodiment is calculated as:

$$Φ i = {Σ}_{1}^{8} {t}_{i} / 8.$$

The cellular pore size for the cellular structure of the matrix is calculated as an average cellular pore size Φ_{2D} for a statistically significant number of cellular pores, i.e. n pores, taken as a two-dimensional value from two-dimensional measurements of cellular pores in the cross-section. Therefore in this embodiment the cellular pore size, expressed as a two-dimensional area, is calculated as:

$${Φ}_{2 D} = {Σ}_{i = {1}^{n}} {Φ}_{i} / n .$$

The three-dimensional value of the cellular pore size, i.e. the volume, for the cellular structure is calculated in this embodiment by applying a normalized correction factor of 1204.3 to the two-dimensional cellular pore size, and therefore as:

$${Φ}_{3 D} = 1204.3 {Φ}_{2 D} .$$

The anisotropy ratio R of the cellular pores is also calculated. As described above, for a given cellular pore a number of values of the width tᵢ are measured, and from these values a maximum value of the width, tₘₐₓ, maybe derived.

For any given cellular pore, the anisotropy ratio Rᵢ is calculated from the maximum width value tₘₐₓ and a value tₚₑᵣₚ of the width that is perpendicular to the maximum width, as shown in FIG. 3.

The anisotropy ratio for any given cellular pore is calculated as follows:

$$R i = {t}_{max} / {t}_{perp} .$$

The anisotropy ratio Rₘₐₓ of the cellular structure of the matrix is calculated as an average anisotropy ratio Rᵢ for a statistically significant number of cellular pores, i.e. n pores, taken as a two-dimensional value from two-dimensional measurements of cellular pores in the cross-section. Therefore in this embodiment the anisotropy ratio Rₘₐₓ of the cellular pore size for the respective first or second cellular structures is calculated as:

$${R}_{max} = {Σ}_{i = {1}^{n}} {R}_{i} / n .$$

For the analysis of the distribution of the size of the cellular pores the standard deviation SD is calculated as:

$$SD = √ ( ( {{Σ}_{i = {1}^{n}} ( {Φ}_{i} - Φ )}^{2} ) / n - 1 )$$

where Φᵢ is the size of each single cellular pore and Φ is the average (by number) cellular pore size of the distribution.

The normalized standard deviation NSD is calculated as:

$$NSD = SD / Φ$$

where Φ is the average (by number) cellular pore size of the distribution.

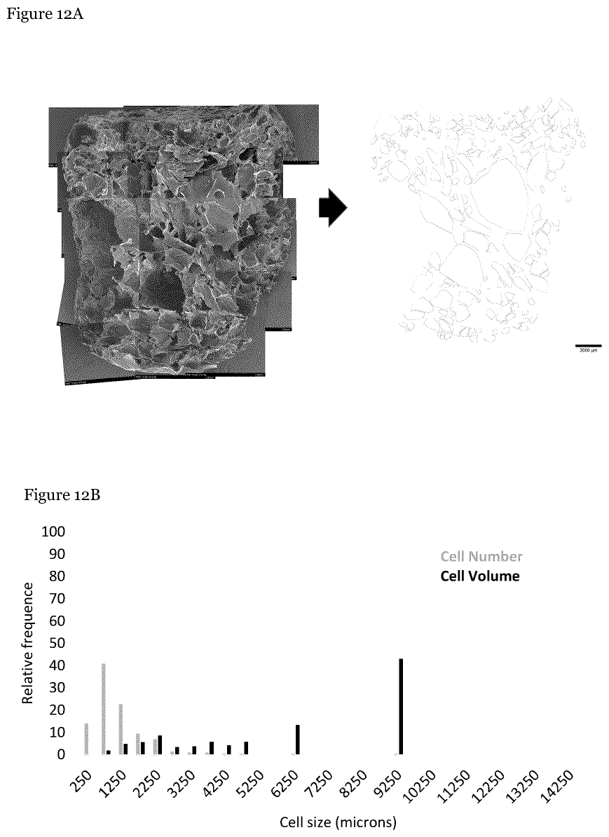

FIG. 12A shows an SEM of a cross section through a product according to an embodiment of the present disclosure, and demonstrates the cellular structure of the internal matrix. A corresponding mask, generated for the purposes of analysis, is also provided. FIG. 12B shows a graph of cell size distribution of the cellular structure shown in FIG. 12A. Parameters from the analysis of the cellular structure in FIG. 12A are provided in Table 3 below.

Finished products according to the present disclosure may have a defined pore size distribution.

In some embodiments, the pore size distribution has a number-average pore size Φ_{2D} within the range of from about 300 to 1100 μm, with a normalised standard deviation NSD of from about 0.6, 0.7 or 0.8 to 1.8. In some embodiments, the pore size distribution has a number-average pore size Φ_{2D} between about 350 and 1050, between about 400 and 1000 μm, between about 500 and 950 μm, between about 650 and 950 μm, between about 700 and 950 μm, between about 750 and 950 μm, between about 800 and 950 μm or between about 850 and 950 μm; or about 900, about 920, about 940, about 950, about 960, about 970, about 980, about 990 or about 1000 μm. In some embodiments, the normalised standard deviation NSD is from about 0.6 to 1.5, 0.65 to 1.5, 0.7 to 1.5 or 0.8 to 1.5, about 0.8-1.3 or about 0.8-1.2. The number-average pore size Φ_{2D} and the normalised standard deviation NSD are calculated as described above.

In some embodiments, the pore size distribution has a number-average pore size Φ_{3D} within the range of from about 400 to 1400 μm. In some embodiments, the pore size distribution has a number-average pore size Φ_{3D} between about 450 and 1350, between about 500 and 1300, between about 550 and 1300, between about 600 and 1300, between about 700 and 1250 μm, between about 800 and 1250 μm, between about 900 and 1250 μm, between about 1000 and 1250 μm, between about 1100 and 1250 μm or between about 1150 and 1250 μm; or about 1190, about 1200, about 1205, or about 1210 μm. The number-average pore size Φ_{3D} is calculated as described above.

In some embodiments, the pore size distribution has from about 8×10² to 2×10⁴ pores per unit area Nᵥ. Optionally, the pore size distribution has from about 8.5×10² to 1×10⁴, from about 8.5×10² to 5×10³, from about 9×10² to 1×10³, from about 9.5×10² to 8×10³, from about 9.5×10² to 5×10³, from about 9.5×10² to 5×10³, from about 9.5×10² to 2×10³, from about 9.6×10² to 1×10³, from about 9.7×10² to 1×10³, or from about 9.7×10² to 9.9×10² pores per unit area Nᵥ. The number of pores per unit area Nᵥ is calculated as described above.

In some embodiments, the cellular pores have a number-average anisotropy ratio Rₘₐₓ of from about 1.4 to 2.2. Optionally, the cellular pores have a number-average anisotropy ratio Rₘₐₓ of from about 1.4 to 2.1, from about 1.5 to 2.0, from about 1.55 to 1.9, from about 1.55 to 1.8, from about 1.6-1.75; or about 1.6 or 1.65. The number-average anisotropy ratio Rₘₐₓ is calculated as described above.

Analysis of the products according to the present disclosure demonstrates a similar level of expansion and internal architecture to traditionally made expanded snack food products. The present disclosure can therefore be used to manufacture expanded non-fried, snack food products comprising a plant-based substrate, which fills a gap in the current snack food market.

The present disclosure further provides a kit for making a non-fried, non-extruded, expanded snack food product using a microwave oven. In preferred embodiments, the kit is suitable for use in a domestic environment.

In some embodiments, the kit comprises a batter according to the present disclosure. Alternatively, the kit may comprise a quantity of substrate; and a quality of emulsifier and starch sufficient to mix with the quantity of substrate and, optionally, added water, to produce a batter suitable for use according to the present disclosure.

Alternatively, the kit may comprise a quantity of emulsifier and starch sufficient to mix with a quantity of a substrate chosen by the user and, optionally, added water, to produce a batter suitable for use according to the present disclosure.

In each case the kit may further comprise one or more individual mould compartments for use with the batter.

In embodiments of the kit comprising a substrate, the substrate may be any substrate discussed in the present disclosure. In embodiments of the kit comprising a starch and emulsifier, the starch and emulsifier maybe as per the present disclosure.

In some embodiments wherein the kit comprises a substrate, the substrate may be in liquid or powdered form; in some such preferred embodiments, the substrate is in powdered form.

The kit may further comprise instructions for the user, detailing, for example, how to make the batter, the amount to dispense into mould compartments and details relating to microwave oven setting and dehydration/finishing time(s).

### Advantages

The inventors of the present disclosure surprisingly discovered that a batter comprising a substrate, such as plant-based substrate, starch, and an emulsifier can be dehydrated using a microwave to produce an expanded snack. The present disclosure thus advantageously allows the creation of non-fried, non-extruded expanded snack food products from wet substrates, and in particular the creation of non-fried, non-extruded expanded snack food products comprising a high level of minimally processed plant substrates, including fresh plant substrates, such as fresh fruit and vegetables. The products have a desirable ‘puffy and light’ low density, high porosity microstructure which is similar to a snack food product which has been traditionally manufactured by extrusion followed by frying; and retain the vibrant colours and flavours of the minimally processed plant-based substrate from which they are made. The method of making the snack food has the advantage of being simple and inexpensive, and can be easily implemented in an industrial or domestic kitchen.

Without being bound by any theory, it is believed that these products are achieved as a result of the use of an explosive dehydration method (i.e. microwaves), which causes a rapid increase in the temperature of the water within the batter, increasing its internal pressure, resulting in the formation of bubbles of different sizes but mainly spherical in shape. The size of the bubbles is controlled as a result of the inclusion of an amphipathic emulsifier, and careful selection of mould (thereby avoiding the centre of the snack simply being a void), whilst the viscosity of the batter helps retain, in particular, pieces of substrate in suspension as the batter gelatinizes. It is believed that the water in the batter starts to evaporate away from the snack at the same time as the batter is solidifying, thereby producing an expanded shape which does not collapse. It is purported that the heating and dehydration needs to be done at a fast pace or the steam would escape faster than the solidification, resulting in a flat, dense product.

The present invention will now be described in greater detail with reference to the following non-limiting Examples.

### EXAMPLES

### Example 1

An experiment was undertaken to demonstrate the surprising finding that an expanded matrix having a texture similar to a traditional (extruded then fried) snack product could be produced by providing a mixture of starch, emulsifier and water, dispensing the mixture in a mould, and dehydrating the mixture with microwaves.

A batter was created as follows:

| Ingredient | Amount (wt %) |
|---|---|
| Waxy maize starch (Precisa Crisp 38 ®) | 23.56 |
| Added Water | 73.44 |
| Salt | 0.81 |
| Lecithin | 2.19 |

The batter was mixed until all ingredients were well combined, but there was no whisking or intentional aeration. The mixture, which resembled a thick batter was then poured into a cuboidal silicone mould (˜7 g per mould cell). The filled moulds were dehydrated in a microwave for 2-3 mins minutes at half power (1300 kW) and 2-3 mins minutes at full power (2600 kW) until the cubes have expanded and are mostly solid. The cubes were then removed from their moulds and finished by baking on a wire tray in the oven at 100 degrees temp for 15-20 minutes. The moisture content following baking was 3%.

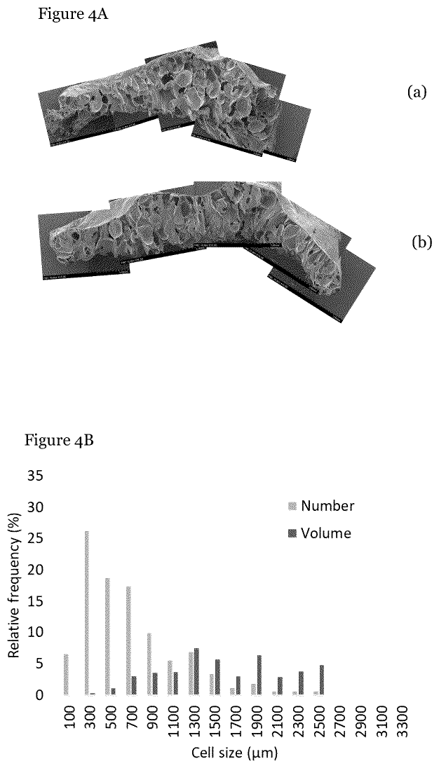

SEM images through a cross-section of two of the resultant product (referred to herein as ‘protoypes’ are shown in FIG. 4A (a) and (b)

FIG. 4B shows a graph of cell size distribution of the cellular structures ((a) and (b)) shown in FIG. 4A. Averaged data from the analysis of the cellular structures of a number of prototypes such as those shown in FIG. 4 (a) and (b) are provided in Table 1 below.

TABLE 1

| Φ_{2D} (μm) | Φ_{3D} (μm) | SD | NSD | Ry/x | Rmax |
|---|---|---|---|---|---|
| 544.6 | 693.2 | 367.5 | 0.67 | 1.38 | 1.88 |

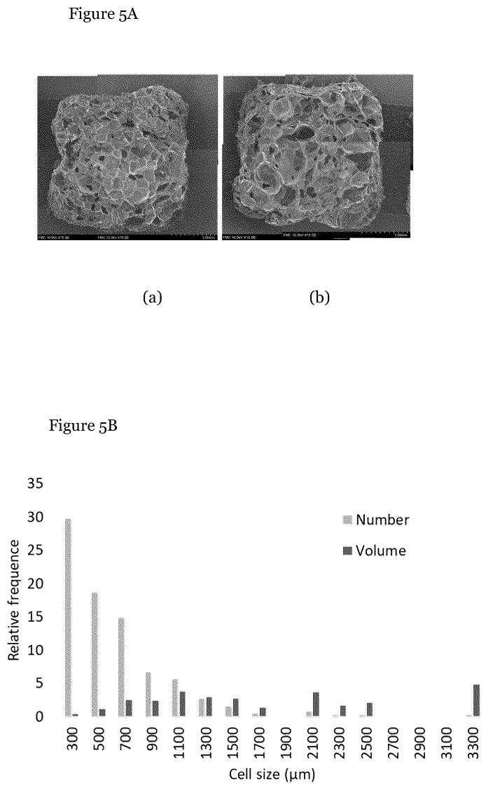

For comparison, SEM images through a cross-section of two Cheetos® are shown in FIG. 5A (a) and (b). Cheetos® are made from enriched corn meal, vegetable oil, cheese seasoning salt, whey protein concentrate, monosodium glutamate, lactic acid, citric acid, yellow 6, and salt, and are manufactured by extrusion followed by frying.

Comparable analysis of the cellular structure of the two Cheetos® shown in FIG. 5A was undertaken. FIG. 5B shows a graph of cell size distribution of the cellular structures ((a) and (b)) shown in FIG. 5A. Averaged data for a number of Cheetos® is provided in Table 2, below.

TABLE 2

| Φ_{2D} (μm) | Φ_{3D} (μm) | SD | NSD | Ry/x | Rmax |
|---|---|---|---|---|---|
| 425.9 | 542.2 | 331.0 | 0.78 | 1.16 | 1.72 |

As can be seen, the prototype products were more elongated in length than the Cheetos®, possibly due to lengthways expansion in the mould, and the cellular voids of the prototypes were more homogeneous, with bigger cells than the Cheetos®. However, the prototypes had a similar internal structure to Cheetos®, as well as a similar overall cell size distribution to Cheetos®.

### Example 2

Products were made in accordance with the present disclosure, using 6 different plant-based substrates and, in each case, adding water.

| Ingredients | Amount (wt %) |
|---|---|
| Pregel Waxy Maize Starch | 11.90 |
| Water | 43.65 |
| Plant-based substrate: Vegetable | 42.66 |
| Salt | 0.50 |
| Lecithin | 1.29 |

The vegetable puree in each case was made from a single vegetable selected from: beetroot, parsnip, green pea, sweet potato, mushroom, red capsicum.
1. IQF (individually quick frozen) vegetables were steamed at 100° C. temp for until cooked through and soft. As an example, for red pepper this takes about 9 minutes.
2. The cooked veg was then pureed using a hand blender into a smooth paste.
3. The vegetable puree was mixed with the water before dry ingredients (pre-gelatinised waxy maize starch, salt and lecithin) were mixed in. The batter was mixed until all ingredients were well combined, but there was no whisking or intentional aeration.
4. The mixture, which resembled a thick batter was then poured into a cuboidal silicone mould (˜7 g per mould cell).
5. The filled moulds were dehydrated in a microwave for 2-3 mins minutes at half power (1300 kW) and 2-3 mins minutes at full power (2600 kW) until the cubes have expanded and are mostly solid.
6. The cubes were then removed from their moulds and finished by baking on a wire tray in the oven at 100 degrees temp for 15-20 minutes.

Finished product density: from 0.05-0.1 g/ml

### Moisture Content:

Batter: 80 wt %
Following microwave dehydration: 12 wt %
Following oven baking: 4-5 wt %

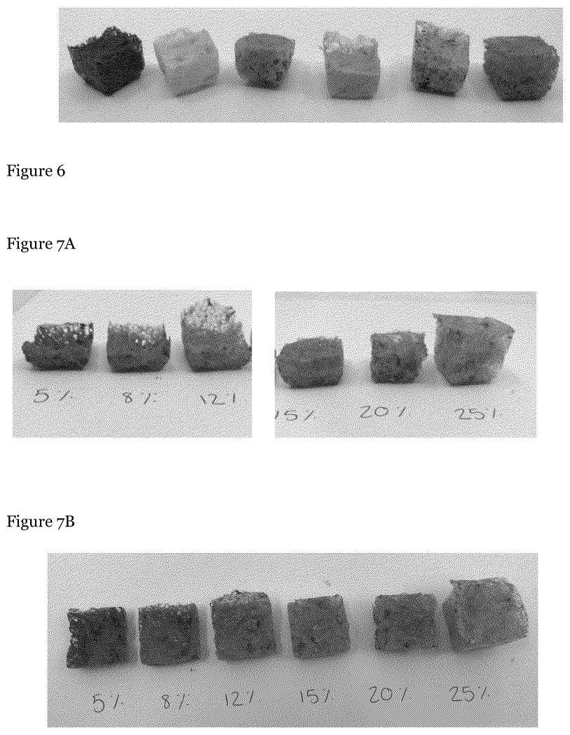

FIG. 6 show images of the finished products, wherein the vegetable puree was (left to right) beetroot, parsnip, green pea, sweet potato, mushroom, red pepper.

### Example 2

Experiments were undertaken to establish the effect of altering the amount of starch in the batter.

Batters were made according to Example 2 using red capsicum, but with, respectively, 5, 8, 12, 15, 20 and 25 wt % pregelatinized waxy corn starch. The amount of added water was altered accordingly in order to give 100 wt %. The batters were dispensed into moulds, dehydrated and finished according to Example 2.

Results are shown in FIG. 7, which demonstrates that increasing amounts of starch resulted in increased expansion of the product with a small ‘collar’ or ‘rim’ at the top where the batter extended above the mould during expansion (FIG. 7A). In addition, increasing amounts of starch resulted in decreased colour intensity (FIG. 7B).

These findings suggest that a range of between about 8 wt % and 25 wt % added starch provides a suitably expanded product.

### Example 4

Experiments were undertaken to establish the effect of using native starches in the batter.

Batters were made with 43.65 wt % water, 42.66 wt % capsicum puree, 0.5 wt % salt and 1.29 wt % lecithin, with 11.9 wt % of either maize starch, waxy maize starch or potato starch. Each batter was dispensed into a mould, dehydrated and finished according to Example 2.

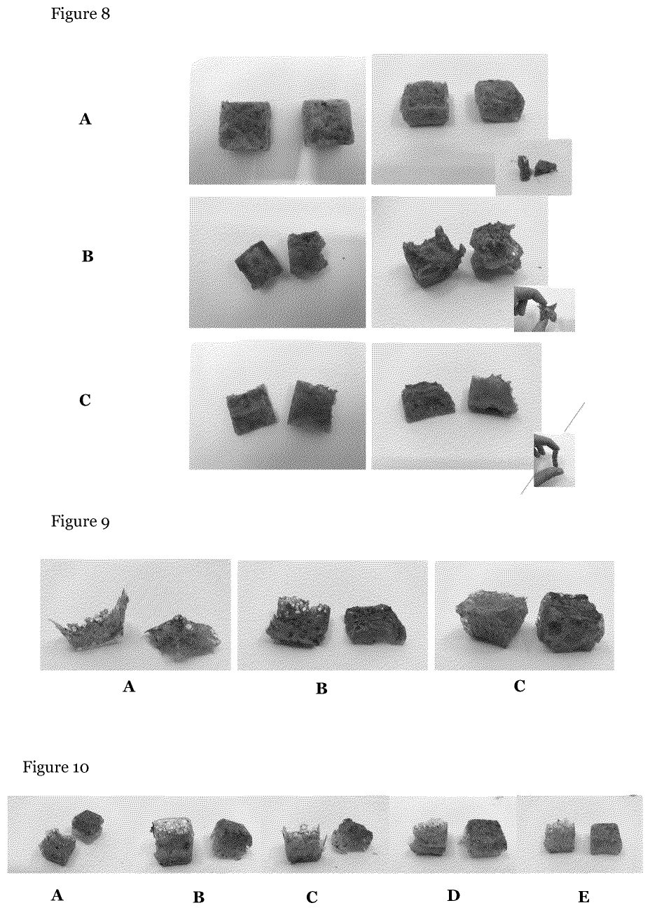

Results are shown in FIG. 8, which demonstrates that the use of maize starch (A), waxy maize starch (B) and potato starch (C) resulted in denser, harder texture than the use of a pre-gelatinized starch.

### Example 5

Experiments were undertaken to establish the effect of removing emulsifier (A) or salt (C) from the batter. These batters were compared with a batter comprising a low level (5 wt %) of added starch (B).

Batter (A) (no emulsifier) comprised:
11.9 wt % starch;
0.5 wt % salt;
43.95 wt % capsicum puree; and
43.65 wt % added water.

Batter (B) (low starch) comprised:
5.29 wt % starch;
2.12 wt % Dimodan® (a distilled monoglyceride made from edible, refined hydrogenated palm oil);
0.53 wt % salt;
45.50 wt % capsicum puree; and
46.56 wt % water.

Batter (C) (no salt) comprised:
11.9 wt % starch;
1.29 wt % lecithin;
43.16 wt % capsicum puree; and
43.65 wt % added water.

Batters were dispensed into moulds, dehydrated and finished according to Example 2.

Results are shown in FIG. 9, which demonstrates that, as expected, the use of 5 wt % added starch (B) resulted in a darker, less expanded product that the use of higher levels of starch (see results in FIG. 7). The removal of salt from the batter did not impact on expansion, resulting in a light, porous product (C). Removal of emulsifier from the batter significantly impacted expansion (A).

### Example 6

Experiments were undertaken to establish the effect of varying the amount of added water to the batter. Batters were made comprising 11.9 wt % starch, 1.29 wt % lecithin and 0.5 wt % salt with, respectively, 15, 30, 45, 60, and 75 wt % added water. Capsicum puree was then added, as required, to reach 100 wt %

Batters were dispensed into moulds, dehydrated and finished according to Example 2.

Results are shown in FIG. 10 (10A: 15 wt % added water; 10B: 30 wt % added water; 10C: 45 wt % added water; 10D: 60 wt % added water and 10E: 75 wt % added water) and demonstrate that lower levels of added water resulted in a darker, harder product, whereas batters comprising higher levels of added water produced a product that was lighter in colour and had a more open bubble structure.

### Example 7

The microstructure of different products was visually compared. Batters were made according to the following recipes:

| | A | B | C | D |
|---|---|---|---|---|
| Ingredient | wt % Amount | | | |
| Waxy maize starch (Precisa Crisp 38 ®) | 18.52 | 12 | 12 | 5.29 |
| Water | 39.74 | 43.5 | 43.5 | 46.56 |
| Red Pepper Puree | 39.821 | 43 | 43 | 45.5 |
| Salt | 0.46 | 0.5 | 0.5 | 0.53 |
| Dimodan ® | 1.46 | 1 | — | 2.12 |
| Lecithin | — | — | 1 | — |

Details were otherwise as per Example 2.

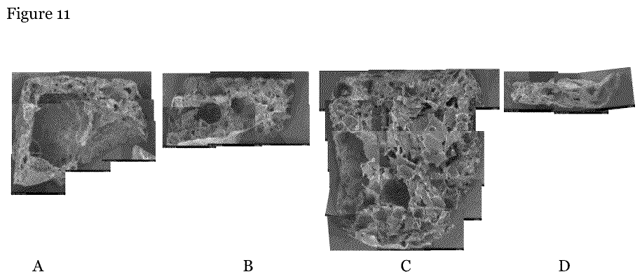

SEM images through a cross-section of products A-D are shown in FIG. 11A.

A visual comparison of product C of FIG. 11A with FIG. 5, which shows SEM images taken through a cross-section of two Cheetos® demonstrates that products according to the present disclosure have a similar level of expansion and internal architecture to known, traditionally made expanded snack food products.

### Example 8

Quantitative analysis was used to compare the microstructure of product C from Example 7, which is in accordance with the present disclosure, with a known, traditionally made, expanded snack food product (Cheetos®).

FIG. 12A shows an SEM of the cellular structure through a cross section of product C, with a corresponding mask for analysis.

FIG. 12B shows a graph of cell size distribution of the cellular structure shown in FIG. 12A. Parameters from the analysis of the cellular structure in FIG. 12A are provided in Table 3 below:

TABLE 3

| Φ_{2D} (μm) | Φ_{3D} (μm) | SD | NSD | Nᵥ (cells/cm³) | Ry/x | Rmax |
|---|---|---|---|---|---|---|
| 946.0 | 1204.3 | 781.5 | 0.83 | 9.8E⁺⁰² | 1.02 | 1.64 |

The product shown in FIG. 12A has a highly expanded structure, with most of the cellular voids having a uniform size distribution, and a size<1250 μm. Some large voids are present, which are likely to be the result of bubble coalescence during dehydration of the batter.

A comparable analysis was conducted on the two Cheetos® shown in FIG. 5A, as discussed above, with FIG. 5B showing the graph of cell size distribution of the cellular structures ((a) and (b)) shown in FIG. 5A. Parameters from the analysis of the cellular structures in FIG. 5A are provided in Table 2 above.

The Cheetos® products (shown in FIG. 5A), similarly to products made according to the present disclosure (shown in FIG. 11A), have a highly expanded structure, with most of the cellular voids having a uniform size distribution and a size comparable to those of the present disclosure (taking into account standard deviation), with some large voids present.

This analysis demonstrates that products according to the present disclosure have a similar level of expansion and internal architecture to known, traditionally made expanded snack food products.

### Example 9

20 different products were made in accordance with the present disclosure, as shown in the table below (note: Precisa Crisp 38® is a waxy maize starch; Naked® Rainbow Machine smoothie contained apple juice from concentrate (from 2.25 apples), kiwi puree (half a kiwi), blueberry puree (46 blueberries), banana puree (half a banana), mango puree (quarter of a mango, blackberry puree (6 blackberries), beet juice (from ⅕th red beet), calcium nitrate, Vitamin E acetate, Niacinamide, Vitamins C, B5, B6, B12 and D3; Alvalle® Gazpacho contained tomato (59%), red pepper (12%), cucumber (12%), onion (9%), extra virgin olive oil (2.6%), white wine vinegar, salt, garlic, lemon Juice (Vegetable Content 93%); Doritos® hot or mild Sala contained tomatoes (68%); pureed, diced, crushed), capsicum (14%), onion (13%), vinegar, salt, sugar, garlic, vegetable gum (xanthan), firming agent (calcium chloride), food acid (citric), coriander, vegetable oil and spice extract (chilli); Pepsi Max® contained carbonated water, colour (caramel E150d), sweeteners (aspartame, acesulfame K), acids (phosphoric acid, citric acid), flavourings (including caffeine), preservative (potassium sorbate); the vanilla ice cream contained whole milk, double cream (27%), demerara sugar, dried skimmed milk, pasteurised egg, maltodextrin, vanilla extract, sugar and ground vanilla pods. An alternative ice cream was also used as a substrate and produced an expanded snack product according to the present disclosure (results not shown here); it which contained reconstituted skimmed milk concentrate, sugar, partially reconstituted buttermilk powder, coconut oil, palm stearin, palm oil, dextrose, palm kernel oil, emulsifier (mono- and di-glycerides of fatty acids), flavouring, stabilisers (locust bean gum, guar gum), vanilla pods, colours (algal carotenes, beetroot red, curcumin); pancake mix powder contained wheat flour, sugar, whey powder, dried egg yolk, dextrose and salt).

| Product Name | Ingredients | % wt Amount |
|---|---|---|
| Thai Butternut | Precisa Crisp ® 38 | 11.90 |
| Squash Curry | Lecithin | 1.29 |
| | Water | 40.00 |
| | Butternut squash (peeled, steamed from fresh, pureed) | 36.90 |
| | Green Thai curry paste | 2.50 |
| | Lime leaf | 1.50 |
| | Thai basil | 1.50 |
| | Miso powder | 0.20 |
| | Ginger (pureed) | 0.99 |
| | Coriander | 0.90 |
| | Galangal | 0.60 |
| | Red chilli (pureed) | 0.40 |
| | Garlic (pureed) | 0.42 |
| Gazpacho Soup | Precisa Crisp ® 38 | 11.90 |
| (finished product | Lecithin | 1.29 |
| shown in FIG. | Alvalle ® Gazpacho | 86.81 |
| 14C) | | |
| Tomato and | Precisa Crisp ® 38 | 11.90 |
| Basil Sauce | Lecithin | 1.29 |
| | Water | 43.65 |
| | Tomato and Basil pasta sauce | 43.16 |
| Rainbow | Precisa Crisp ® 38 | 11.90 |
| Smoothie | Lecithin | 1.29 |
| | Water | 40.00 |
| | Naked ® Rainbow Machine Smoothie | 46.31 |
| | Salt | 0.50 |
| Yoghurt, | Precisa Crisp ® 38 | 7.20 |
| Strawberry, and | Lecithin | 1.20 |
| Oats | Water | 33.60 |
| | Strawberry puree | 45.80 |
| | Oats (rolled oats, blended in a small food processer) | 4.8 |
| | Plain yoghurt | 7.20 |
| | Salt | 0.20 |
| Pancake with | Precisa Crisp ® 38 | 10.00 |
| Maple Syrup | Lecithin | 1.29 |
| | Water | 73.81 |
| | Pancake mix powder | 8.00 |
| | High Oleic Sunflower Oil (HOSO) | 1.90 |
| | Vanilla extract | 3.00 |
| | Salt | 0.20 |
| | Maple syrup | 2.00 |
| Japanese Pea | Precisa Crisp ® 38 | 11.90 |
| | Lecithin | 1.29 |
| | Water | 45.00 |
| | Pea (steamed from frozen, pureed) | 38.40 |
| | Garlic (Pureed) | 0.41 |
| | Ginger (Pureed) | 0.90 |
| | Miso powder | 0.30 |
| | Black sesame seeds | 1.50 |
| | Soy sauce | 0.30 |
| Hot/Mild Salsa | Precisa Crisp ® 38 | 11.90 |
| (finished product | Lecithin | 1.29 |
| made with hot | Water | 43.65 |
| salsa shown in | Doritos ® Hot salsa/Mild salsa | 43.15 |
| FIG. 14B) | | |
| Carrot and | Precisa Crisp ® 38 | 11.90 |
| Coriander | Lecithin | 1.29 |
| | Water | 42.81 |
| | Carrot (steamed from frozen, pureed) | 42.00 |
| | Coriander | 1.60 |
| | Salt | 0.40 |
| Cauliflower | Precisa Crisp ® 38 | 11.90 |
| Cheese | Lecithin | 1.29 |
| | Water | 45.31 |
| | Cauliflower (steamed from frozen, pureed) | 21.70 |
| | Cheddar cheese (Grated) | 19.00 |
| | Ground nutmeg | 0.30 |
| | Salt | 0.50 |
| Sweetcorn and | Precisa Crisp ® 38 | 11.90 |
| Salsa | Lecithin | 1.29 |
| (finished product | Water | 44.00 |
| shown in FIG. | Sweetcorn (steamed from frozen, pureed) | 22.31 |
| 14E) | Doritos ® Mild salsa | 20.00 |
| | Salt | 0.50 |
| Apple | Precisa Crisp ® 38 | 9.00 |
| (finished product | Lecithin | 1.05 |
| shown in FIG. | Water | 65.00 |
| 14A) | Apple puree | 24.00 |
| | Salt | 0.40 |
| Chocolate Milk | Precisa Crisp ® 38 | 11.90 |
| | Lecithin | 1.29 |
| | Chocolate Milk (Chocolush ®) | 86.31 |
| | Salt | 0.50 |
| Strawberry and | Precisa Crisp ® 38 | 10.11 |
| Pineapple | Lecithin | 1.26 |
| | Water | 40.40 |
| | Strawberry (pureed) | 12.63 |
| | Pineapple (pureed) | 35.40 |
| | Salt | 0.20 |
| Vanilla Ice | Precisa Crisp ® 38 | 11.90 |
| Cream | Lecithin | 1.29 |
| | Water | 70.00 |
| | Vanilla ice cream (melted) | 37.48 |
| | Salt | 0.15 |
| Pepsi Max | Precisa Crisp 38 | 14.00 |
| (finished product | Lecithin | 1.29 |
| shown in FIG. | Water | 43.65 |
| 14D) | Pepsi Max ® | 40.65 |
| | Salt | 0.50 |
| Hummus and | Precisa Crisp ® 38 | 11.90 |
| Red Pepper | Lecithin | 1.29 |
| | Water | 54.42 |
| | Hummus | 10.76 |
| | Red pepper (steamed from frozen, pureed) | 21.54 |
| | Salt | 0.09 |
| Yoghurt, | Precisa Crisp ® 38 | 7.70 |
| Pineapple and | Lecithin | 0.80 |
| Coconut | Water | 22.40 |
| | Pineapple (pureed) | 51.30 |
| | Oat (rolled oats, blended in a small food processer) | 4.80 |
| | Plain yoghurt | 9.60 |
| | Salt | 0.20 |
| | Desiccated coconut | 3.20 |
| Red Pepper and | Precisa Crisp ® 38 | 7.70 |
| Manchego | Lecithin | 1.00 |
| Cheese | Water | 32.32 |
| | Red pepper (steamed from frozen, pureed) | 31.59 |
| | Manchego cheese (grated) | 24.24 |
| | Cayenne pepper | 0.07 |
| | Salt | 0.37 |
| | Black pepper | 0.22 |
| | Parsley | 2.20 |
| | Red Wine Vinegar powder | 0.80 |
| Peanut Butter | Precisa Crisp ® 38 | 11.91 |
| and Chocolate | Lecithin | 1.29 |
| | Water | 65.18 |
| | Crunchy peanut butter | 21.53 |
| | Salt | 0.09 |

### Method

Batters were prepared according to the recipes shown: dry ingredients (e.g. Precisa Crisp® 38, lecithin and salt) were combined in one bowl; wet ingredients were combined in another bowl; the dry ingredients were then gradually mixed into the wet ingredients using a hand whisk.

The table below shows the moisture content and viscosity of some of the batters tested

| | | Force | Viscosity as |
|---|---|---|---|
| | Moisture | required to | measured using a |
| | content of | compress the | Bostwick consistometer |
| | batter | batter to | (distance travelled |
| Product name | (wt %) | 25 mm (g) | in 1 minute) (cm) |
| Thai butternut | 81.9 | | |
| squash curry | | | |
| Pepsi Max ® | 85.1 | 245.1 g | 4.2 |
| Pancake with | 78.5 | 71.9 | 7.8 |
| Maple Syrup | | | |
| Japanese Pea | 75.9 | 371.6 | 3.1 |
| Cauliflower Cheese | 73.4 | 211.3 | 6.2 |
| Vanilla Ice cream | 78.0 | 107.4 | 11.2 |
| Sweetcorn & Salsa | 79.7 | 256.2 | 5.5 |
| Red pepper & | 69.0 | 247.5 | 7.0 |
| Manchego cheese | | | |

A mould was used which had 20 compartments, each 2.5 cm×2.5 cm×2.5 cm, with each compartment separated only by a dividing wall. 6 to 7 g of batter was added to alternate compartments as shown below:

The filled moulds were placed in a microwave (as used in Example 2), and dehydrated in multiple short microwaving steps as followed: at half power (750 W) for 30 seconds followed by 3×10 seconds; followed by 9×6 seconds; followed by 2×20 s; followed by full power (1500 W) for 20 seconds, followed by 2×30 seconds; followed by 1×20 seconds; followed by one 10 seconds. At the end of each time interval the mould was rotated 90° (as the microwave used did not have an internal rotating plate; the rotation would not necessarily be required if an internal rotating plate were present). At the end of microwave dehydration the mould was removed from the microwave and the product removed from the mould compartments and baked in an oven for 15 minutes at 100° C. The resultant cubes were expanded and mostly solid.

### Example 10—Microwave Dehydration Only (No Finishing Step)

Batters were prepared according to the present disclosure. A mould was used which had 20 compartments, each 2.5 cm×2.5 cm×2.5 cm, with each compartment separated only by a dividing wall. 4 g-5 g of batter was added to each compartment.

The mould was placed in a Kenwood domestic microwave (model K23MSS15: related voltage: 230-240V˜50 Hz; power input microwave: 1200-1250 W; Frequency: 2450 MHz; power output microwave: 750-800 W), and the microwave set to the ‘Medium’ power setting. The time of exposure to microwaves varied slightly depending upon the moisture content of the batter.

Microwave dehydration was carried out for a period of 1 min, which was repeated 3 further times to give a total dehydration time of 4 minutes. The products were then visually inspected and if needed, microwave dehydration was carried out for a further period of 30 seconds followed by visual inspection, and if necessary, a further period of 30 seconds. As such, total microwave dehydration time was between 5 and 6 minutes. The shorter (30 s) time intervals were used to help ensure that the product did not overcook or burn.

The dehydrated products were then removed from the moulds. No finishing step(s) was undertaken.

### Consumer Testing

The products resulting from Example 9 were ranked by different groups of consumers. Generation Z consumers (18-25 years old in at least part-time work) considered the most desirable products to be Thai butternut squash curry, gazpacho soup, pancake with maple syrup and Japanese pea; Family group consumers (parents with children aged 3-9 years) considered the most desirable products to be cauliflower cheese, sweetcorn and salsa and vanilla ice cream; and the midlife consumer group (45-65 years old) considered the most desirable products to be gazpacho soup and red pepper and manchego cheese.

### Comparative Example: ‘Baby puff’ recipe from Jean Choi's website ‘Whatgreatgrandmaate’

A batter was made as follows: 120 g oat flour; 225 g fruit puree; 1 tbsp coconut oil melted; 2 egg yolks; 1 tsp baking powder.

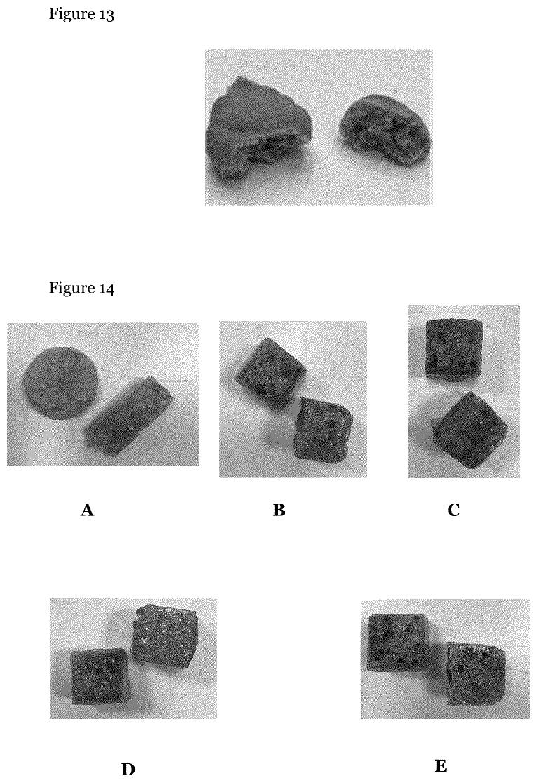

Ingredients were placed in a bowl and mixed until a batter resembling a thick pancake batter was formed, adding water 1 tbsp at a time if necessary. A conventional oven was heated to 180° C. and a baking sheet lined with parchment paper. The batter was poured into a piping bag or plastic resealable bag with one of the corners snipped off, and the batter piped onto the baking sheet in small amounts, making sure they didn't touch each other. The tray was then placed in the oven for 8 minutes, turning halfway through. The oven temperature was then lowered to 120° C. for another 20-30 minutes (depending on the shape and size of the puffs), until the puffs are dry to touch and lightly golden on the sides and the bottom. Puffs were removed from the oven, transfer to the countertop, and cool completely in the baking sheet. The resultant product is shown in FIG. 13, and illustrates a dense, minimally expanded product.

Various modifications to the embodiments of the present invention described herein will be readily apparent to those skilled in the art and such modifications are included within the scope as defined in the appended claims.

In addition, there are provided the following technological aspects:

1. A non-fried expanded snack food product comprising plant-based content, emulsifier and starch, wherein the snack food product comprises a rigid matrix comprising the plant-based content, wherein the matrix defines a cellular structure having a pore size distribution, wherein the pore size distribution has a number-average pore size Φ_{2D} within the range of from 300 to 1100 μm with a normalised standard deviation of from 0.8 to 1.8.

2. A non-fried expanded snack food product according to aspect 1, wherein the plant-based content (a) does not comprise more than 15 wt % wheat, maize, rice, barley, oats, millet, rye, sorghum, spelt, quinoa or buckwheat; and/or (b) does not comprise more than 15 wt % potato.

3. A non-fried expanded snack food product according to aspect 1 or aspect 2 wherein the pore size distribution has a number-average pore size Φ_{2D} within the range of from 400 to 1000 μm with a normalised standard deviation of from 0.8 to 1.5; optionally wherein the pore size distribution has a number-average pore size Φ_{2D} within the range of from 850 to 950 μm with a normalised standard deviation of from 0.8 to 1.2.

4. A non-fried expanded snack food product according to any one of aspects 1 to 3, wherein the pore size distribution has a number-average pore size Φ_{3D} within the range of from 400 to 1400 μm, optionally wherein the pore size distribution has a number-average pore size Φ_{3D} within the range of from to 1150 and 1250 μm.

5. A non-fried expanded snack food product according to any one of aspects 1 to 4, wherein the pore size distribution has from 8×10² to 2×10⁴ pores per unit area Nᵥ, optionally wherein the pore size distribution has from about 8.5 to 9.9×10² pores per unit area Nᵥ.

6. A non-fried expanded snack food product according to any one of aspects 1 to 5, wherein the cellular pores have a number-average anisotropy ratio Rₘₐₓ of from 1.4 to 2.2, optionally wherein the cellular pores have a number-average anisotropy ratio Rₘₐₓ of from 1.6-1.75; or 1.6 or 1.65.

7. A non-fried expanded snack food product according to any one of aspects 1 to 6, having a plant-based content of from 15 to 70 wt % based on the weight of the snack food product.

8. A non-fried expanded snack food product according to any one of aspects 1 to 6, having a plant-based content of from 19 to 70 wt % based on the weight of the snack food product.

9. A non-fried expanded snack food according to any one of aspects 1 to 8 wherein the moisture content of the snack food is from 0.5 to 5 wt %.

10. A batter for making a non-fried expanded snack food product according to any one of aspects 1 to 9, comprising a plant-based substrate, emulsifier and starch, wherein the batter comprises: (a) about 20% to 95% plant based substrate; (b) about 0.3% to 2.5% emulsifier; (c) about 8% to 25% starch; (d) optionally, added water.

11. A batter according to aspect 10, wherein the plant-based substrate: i comprises one or more fresh vegetables and/or fruits; ii does not comprise more than about 15 wt % wheat, maize, rice, barley, oats, millet, rye, sorghum, spelt, quinoa or buckwheat; and/or iii does not comprise more than about 15 wt % potato.

12. A batter according to aspect 10 or 11 wherein the batter has a moisture content of about 55-90 wt % based on the weight of the batter.

13. A batter according to any one of aspects 10 to 12 wherein the starch is a pre-gelatinized starch.

14. A method for making a non-fried expanded snack food product comprising: (i) providing a plant-based substrate; (ii) optionally processing the plant based substrate to provide a rough puree; (iii) providing an emulsifier; (iv) providing a starch, optionally wherein the starch is a pregelatinized starch; (v) mixing the plant-based substrate, emulsifier and starch, optionally with added water, to form a batter having a moisture content of about 55 to 90 wt % based on the weight of the batter; (vi) dispensing the batter into individual mould compartments; and (vii) dehydrating the batter using microwave to produce a dehydrated product having a moisture content of about 2 to 20 wt % based on the weight of the dehydrated product.

15. A method according to any one of aspects 9 to 12 wherein step (ii) involves cooking or partial cooking of the substrate to soften its cell walls and/or reducing the substrate in size to no more than 5 mm², no more than 4 mm² or no more than 3 mm².

16. A method according to aspect 14 or 15, wherein the individual mould compartments are at least 5 mm apart, optionally wherein the compartments are arranged in a toroidal geometry with one or more empty (i.e. non-batter containing) compartments in the centre.

17. A method according to any one of aspects 14 to 16 further comprising (viii) a finishing step to provide a finished product having a moisture content about 3-10 wt % based on the weight of the finished product, optionally wherein the finishing step comprises baking the product.

18. A snack food product obtained by the method of any one of aspects 14 to 17.

19. A non-fried, non-extruded, expanded snack food product comprising an edible substrate, emulsifier and starch, wherein the snack food product comprises an expanded rigid matrix comprising the substrate.

20. A non-fried, non-extruded, expanded snack food product according to aspect 1, wherein the substrate does not comprise:
i. a leavening or raising agent;
ii. egg, or a component of egg;
iii. an isolated plant protein; and/or
iv. more than 15 wt % potato.

21. A non-fried, non-extruded, expanded snack food product according to aspect 19 or aspect 20, wherein the substrate does not comprise yeast, sodium bicarbonate, baking powder, ammonium carbonate, ammonium bicarbonate or calcium azide.

22. A non-fried, non-extruded, expanded snack food product according to any one of aspects 19 to 21, wherein the substrate comprises:
(a) a dairy product, optionally wherein the substrate is ice cream;
(b) a base for a product, optionally wherein the substrate is liquid or powdered pancake mix.

23. A non-fried, non-extruded, expanded snack food product according to any one of aspects 9 to 22, wherein the snack food product comprises from about 15 wt % to about 85 wt % substrate based on the weight of the snack food product; optionally wherein the snack comprises from about from about 19 wt % to about 70 wt % substrate based on the weight of the snack food product.

24. A non-fried, non-extruded, expanded snack food product according to any of aspects 19 to 23, wherein the matrix defines a cellular structure having a pore size distribution, wherein the pore size distribution:
(a) has a number-average pore size Φ_{2D} within the range of from 300 to 1100 μm with a normalised standard deviation of from 0.8 to 1.8;
(b) has a number-average pore size Φ_{3D} within the range of from 400 to 1400 μm, optionally wherein the pore size distribution has a number-average pore size Φ_{3D} within the range of from to 1150 and 1250 μm; and/or
(c) has from 8×10² to 2×10⁴ pores per unit area Nᵥ, optionally wherein the pore size distribution has from about 8.5 to 9.9×10² pores per unit area Nᵥ and/or
(d) wherein the cellular pores have a number-average anisotropy ratio Rₘₐₓ of from 1.4 to 2.2, optionally wherein the cellular pores have a number-average anisotropy ratio Rₘₐₓ of from 1.6-1.75; or 1.6 or 1.65.

25. A non-fried, non-extruded, expanded snack food product according to any one of aspects 19 to 24, wherein the moisture content of the snack food is from about 0.5 to about 5 wt %.

26. A non-fried, non-extruded, expanded snack food product according to any one of aspects 19 to 25, wherein the starch is a pre-gelatinized starch.

27. A batter for making a non-fried, non-extruded, expanded snack food product according to any one of aspects 19 to 26, wherein the batter comprises:
a. about 20% to about 95% substrate;
b. about 0.3% to about 2.5% emulsifier;
c. about 8% to about 25% starch;
d. optionally, added water,
wherein the batter has a moisture content of about 65 to about 85 wt % based on the weight of the batter.

28. A method for making a non-fried, non-extruded, expanded snack food product comprising:
(i) providing an edible substrate;
(ii) optionally processing the substrate;
(iii) providing an emulsifier;
(iv) providing a starch, optionally wherein the starch is a pregelatinized starch;
(v) mixing the substrate, emulsifier and starch, optionally with added water, to form a batter having a moisture content of about 65 to about 85 wt % based on the weight of the batter;
(vi) dispensing the batter into individual mould compartments; and
(vii) dehydrating the batter using microwaves to produce a dehydrated product having a moisture content of around 2 to around 20 wt % based on the weight of the dehydrated product.

29. A method according to aspect 28, wherein the substrate comprises no more than 20 wt % substrate in powdered or granulated form.

30. A method according to aspect 28 or aspect 29 wherein the substrate is one or more of:
(a) a dairy product, optionally wherein the substrate is ice cream;
(b) a base for a product, optionally wherein the substrate is liquid or powdered pancake mix.

31. A method according to any one of aspects 28 to 30, wherein the individual mould compartments are at least 5 mm apart, optionally wherein the compartments are arranged in a toroidal geometry with one or more empty (i.e. non-batter containing) compartments in the centre.

32. A method according to any one of aspects 28 to 31 further comprising (viii) a finishing step to provide a finished product having a moisture content about 3-10 wt % based on the weight of the finished product, optionally wherein the finishing step comprises baking the product.

33. A snack food product obtained by the method of any one of aspects 28 to 32.

34. A kit for making a non-fried, non-extruded, expanded snack food product, wherein the kit comprises:
(a) a batter according to aspect 27, optionally further comprising one or more individual mould compartments for use with the batter; or
(b) a quantity of substrate; and a quality of emulsifier and starch sufficient to mix with the quantity of substrate and, optionally, added water, to produce a batter having a moisture content of about 65 to about 90 wt % based on the weight of the batter; optionally further comprising one or more individual mould compartments for use with the batter;
(c) a quantity of emulsifier and starch sufficient to mix with a quantity of a substrate and, optionally, added water, to produce a batter having a moisture content of about 65 to about 90 wt % based on the weight of the batter; optionally further comprising one or more individual mould compartments for use with the batter.

35. A kit according to aspect 34(b), wherein the substrate comprises one or more of a dairy product, or a base for a product; optionally wherein the substrate comprises ice cream or pancake mix.

36. A kit according to aspect 34(b) or (c) or aspect 35, wherein the substrate is in liquid or powdered form.

1. A non-fried, non-extruded, expanded snack food product comprising a plant-based substrate, emulsifier and starch, wherein the snack food product comprises a rigid matrix comprising the plant-based substrate, wherein the rigid matrix has an expanded structure comprising cellular voids and wherein the plant-based substrate comprises:
(a) one or more fruits and/or vegetables; and
(b) no more than 20 wt % of the substrate in powdered or granulated form.

2. A non-fried, non-extruded, expanded snack food product as claimed in claim 1, wherein the one or more fruits and/or vegetables are fresh fruits and/or vegetables; or are fresh fruits and/or vegetables that have been frozen.

3. A non-fried, non-extruded, expanded snack food product as claimed in claim 1, wherein the plant-based substrate:
(a) does not comprise more than 15 wt % wheat, maize, rice, barley, oats, millet, rye, sorghum, spelt, quinoa or buckwheat;
(b) does not comprise more than 15 wt % potato; or
(c) does not comprise a cereal crop.

4. A non-fried, non-extruded, expanded snack food product according to claim 1, wherein the snack food product comprises from about 15 wt % to about 70 wt % plant-based substrate based on the weight of the snack food product.

5. A non-fried, non-extruded, expanded snack food product as claimed in claim 1, wherein the rigid matrix defines a cellular structure having a pore size distribution, wherein the pore size distribution:
(a) has a number-average pore size ϕ_{2D} within the range of from 300 to 1100 μm with a normalized standard deviation of from 0.8 to 1.8;
(b) has a number-average pore size ϕ_{3D} within the range of from 400 to 1400 μm; and/or
(c) has from 8×10² to 2×10⁴ pores per unit area Nᵥ, and/or
(d) wherein the cellular pores have a number-average anisotropy ratio Rₘₐₓ of from 1.4 to 2.2.

6. A non-fried, non-extruded, expanded snack food product as claimed in claim 1, wherein the plant-based substrate:
(a) comprises no more than 5 wt % of the substrate in powdered or granulated form; or
(b) is not in powdered or granulated form.

7. A non-fried, non-extruded, expanded snack food product according to claim 1, wherein the moisture content of the snack food is from about 0.5 to about 5 wt %.

8. A non-fried, non-extruded, expanded snack food product according to claim 1, wherein the starch is a pre-gelatinized starch.

9. A non-fried, non-extruded, expanded snack food product according to claim 1, having a density of from 0.05-0.1 g/ml.

10. A batter for making a non-fried, non-extruded, expanded snack food product according to claim 1, wherein the batter comprises:
(a) about 20% to about 95% of a plant based substrate;
(b) about 0.3% to about 2.5% of an emulsifier;
(c) about 8% to about 25% of a starch;
(d) optionally, added water,
wherein the batter has a moisture content of about 65 to about 85 wt % based on the weight of the batter.

11. A method for making a non-fried, non-extruded, expanded snack food product comprising a plant-based substrate, comprising:
(i) providing a plant-based substrate comprising one or more fruits and/or vegetables, wherein no more than 20 wt % of the substrate is in powdered or granulated form;
(ii) optionally processing the plant-based substrate to provide a rough puree;
(iii) providing an emulsifier;
(iv) providing a starch;
(v) mixing the plant-based substrate, emulsifier and starch, optionally with added water, to form a batter having a moisture content of about 65 to about 85 wt % based on the weight of the batter;
(vi) dispensing the batter into individual mold compartments; and
(vii) dehydrating the batter using microwaves to produce a dehydrated product having a moisture content of about 2 to about 20 wt % based on the weight of the dehydrated product.

12. A method as claimed in claim 11, wherein the plant-based substrate:
(a) comprises no more than 5 wt % substrate in powdered or granulated form; or
(b) is not in powdered or granulated form.

13. A method as claimed in claim 11 wherein the one or more fruits and/or vegetables are fresh fruits and/or vegetables, or are fresh fruits and/or vegetables that have been frozen.

14. A method as claimed in claim 11, wherein the plant-based substrate:
(a) does not comprise more than about 30 wt % cereal crop;
(b) does not comprise more than about 15 wt % wheat, maize, rice, barley, oats, millet, rye, sorghum, spelt, quinoa or buckwheat; and/or
(c) does not comprise more than about 15 wt % potato.

15. A method as claimed in claim 11 further comprising (viii) a finishing step to provide a finished product having a moisture content of about 3-10 wt % based on the weight of the finished product.

16. (canceled)

17. (canceled)
